(19) United States
(12) Patent Application Publication
(10) Pub. No.: US 2010/0173795 A1
(43) Pub. Date: Jul. 8, 2010

(54) HIV and Hepatitis C Microarray to Detect Drug Resistance

(75) Inventor: Michael J. Kozal, Guilford, CT (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignees: Yale University, New Haven, CT (US); The United States Government as Represented by the Department of Veterans Affairs, Washington, DC (US)

(21) Appl. No.: 12/514,982

(22) PCT Filed: Nov. 16, 2007
(86) PCT No.: PCT/US2007/024037

§ 371 Date: Mar. 18, 2010

Related U.S. Application Data
(60) Provisional application No. 60/859,587, filed on Nov. 17, 2006.

(51) Int. Cl. C40B 30/04; C40B 40/08

(52) U.S. Cl. 506/9; 506/17

(57) ABSTRACT

The invention provides arrays and probes for resequencing gene sequences of HIV and HCV using an array of probes complementary to a set of reference sequences, and to each possible single nucleotide substitution of the reference sequences, and for identifying known mutations in HIV and HCV gene sequences associated with resistance to antiviral therapy. Methods of identifying mutations in HIV and HCV sequences, methods of characterizing HIV and HCV isolates, and methods of evaluating and optimizing a patient's antiviral therapy regimen are also provided.

### BACKGROUND OF THE INVENTION

The virus population in a patient infected with Human Immunodeficiency Virus (HIV) or Hepatitis C Virus (HCV) exists as viral quasispecies, or “swarm” of genetically diverse viral variants. Using traditional genotypic mutation assays, not all variants of the quasispecies can be detected. Typically, existing genotypic mutation assays detect a particular viral variant only if it represents at least about 25% of the quasispecies. But research suggests that resistant viral variants making up only about 0.5-1.0% of the quasispecies can be clinically important because this low abundance viral variant can rapidly expand under the pressure of drug selection and lead to antiviral therapy failure.

New technologies able to rapidly and accurately detect and monitor all, including low abundance, HIV and HCV resistant strains would serve to greatly improve patient care. For example, a drug resistant viral strain that is the dominant variant when drug selection pressure is present usually becomes a minority viral strain in a patient's plasma after drug pressure is removed. When the minority viral strain falls below a level of about 25% of the quasispecies, traditional genotypic mutation assays no longer detect these low abundance viral variants. For example, the Sanger sequencing method, used in FDA approved genotypic mutation assays to detect mutations associated with drug resistance, is typically restricted to detecting mutant strains of at least about 25% abundance. Moreover, because viral genes coding for enzymes targeted by antiviral therapy can be several hundred to several thousand of nucleotides long, the use of traditional techniques, to detect and monitor genetic mutations associated with HIV and HCV drug resistance generally requires extensive DNA sequencing.

Currently, quantitative genotypic mutation assays are not available for the clinical management of patients with HIV and/or HCV infections. The predominant experimental assays currently used or described in the literature are based upon allele-specific polymerase chain reaction (PCR) assays designed to detect only a few critical known viral gene resistance mutations. For example, allele-specific PCR assays for HIV drug resistance mutations in HIV in patients' plasma were developed and used early in HIV drug resistance research (Kozal et al., U.S. Pat. No. 5,650,268; Kozal et al., U.S. Pat. No. 5,631,128; Kozal et al., U.S. Pat. No. 5,856,086). Allele-specific real-time PCR assays emerged in research of low abundance viral variants because the assay is able to monitor and to quantitate specific mutations known to be associated with resistance to antiviral therapies. For example, allele-specific PCR assays have been used to detect and monitor the known reverse transcriptase (RT) mutation K103N for non-nucleoside RT inhibitor resistance in HIV positive mothers treated with nevirapine to prevent the transmission of HIV to their children (Johnson et al., 2006, Antiviral Therapy 11:S79; Svarovoskaia et al., 2006, Antiviral Therapy 11: S78; Palmer et al., 2006, AIDS 20:701-710). But incorporating quantitative allele-specific PCR assays into clinical care would require numerous assays to detect all possible resistance mutations that could arise. With more than 80 HIV drug resistance mutations known and listed by the International AIDS Society (www<dot>iasociety<dot>org) and in the Stanford University HIV Drug Resistance Database (hivdb<dot>stanford<dot>edu/index<dot>html), the need to detect and monitor the many different and emerging resistance mutations has increased. A clinician using a quantitative genotypic mutation assay in the clinic would rather be able to simultaneously detect all possible known, and as yet unknown, resistant variants, even when a particular variant makes up only a small fraction of the patient's viral population. A diagnostic tool able to detect drug resistant viral strains, even when a strain constitutes only a minor fraction, for example about 1%, of the circulating viral quasi-species population in a patient sample, would enable clinicians to better tailor individual therapy with the best antiviral regimens against particular resistant strains.

In the US there are an estimated 3 million persons infected with Hepatitis C (HCV), 1 million infected with HIV, and 250,000 persons co-infected with both HIV and HCV (Alter et al., 1999, N Engl J Med 341:556-562; Nakano et al., 2004, J Infect Dis 190:1098-1108; National Institutes of Health Consensus Development Conference Panel Statement: Management of Hepatitis C: 2002—Jun. 10, 2002, 2002 Hepatology 36:S3-S20). Approximately half of HCV-infected patients treated with pegylated interferon and ribavirin do not achieve a sustained virologic response (SVR), especially those infected with HCV genotype 1 strains, which is the most common genotypic variant in the US (Alter et al., 1999, N Engl J Med 341:556-562; Nakano et al., 2004, J Infect Dis 190:1098-1108; National Institutes of Health Consensus Development Conference Panel Statement: Management of Hepatitis C: 2002—Jun. 10, 2002, 2002 Hepatology 36:S3-S20).

In HIV-HCV coinfected patients, SVR rates are even lower, estimated at about 30%. Genetic changes occurring within the HCV NS3, NS4A, NS4B, NS5A and NS5B genes have been associated with resistance to currently approved anti-HCV agents, as well as to agents still undergoing clinical development (Valery et al., 2003, J Virol 77:11459-11470; Pawlotsky et al., 2003, Antiviral Research 59: 1-11; Pawlotsky et al., 2003, Current Opinion in Infectious Diseases 16:587-592; Samuel, 2001, Clin Microbial Rev 14:778-809; Enomoto et al., 1995, J Clin Invest 96:224-230; Enomoto et al., 1996, N Engl J Med 334:77-81; Pascu et al., 2004, Gut 53: 1345-1351; Schinkel et al., 2004, Antivi Ther 9:275-286; Witherell et al., 2001, J Med Virol 63:8-16; Nousbaum et al., 2000, J Virol 74:9028-9038; Sarrazin et al., 2002, J Virol 76:11079-11090; Castelain et al., 2002, J Infect Dis 185:573-583; Young et al., 2003, Hepatology 38:869-878, Trozzi et al., 2003, J Virology 77:3669-3679; Lohmann et al., 1999, Science 285:110-113; Lu et al., 2004, Antimicrob Agents Chemother 48:2260-2266; Lin et al., 2004, J Biol Chem 279:17508-17514; Sarisky et al., 2004, J Antimicrobial Chemo 54: 14-16; Migliaccio et al., 2003, J. Biol Chem 278:49164-49170; Deval Jet al., 2006, 11:S3; Pogam et al., 2006, Antiviral Therapy 11:S5; Molla et al., 2006, Antiviral Therapy 11:S6; Olsen et al., 2006, Antiviral Therapy 11:S7). The successful use of existing agents, as well as the development of new anti-HCV agents must address the emergence of resistant HCV strains. It is common in research to identify mutations occurring within the NS3, NS4A, NS4B, NS5A, and NS5B genes by sequencing. Using standard automated sequencing methods, this requires at least about 12-20 sequencing primer sets and, because the HCV genes that encode for the proteins targeted by anti-HCV agents have >5 Kb bases, extensive gene sequencing is required.

DNA microarrays are a powerful technology that could serve to greatly improve patient care. DNA microarray assays can detect mismatches, deletions and insertions, either by designing probes for these predicted changes, or by the detection of loss of signal from the predicted probe intensity (Gresham et al., 2006, Science 311:1932-1936; Lipshutz et al., 1995, Biotechniques 19:442-447; Cutler et al., 2001, Genome Research 11:1913-1925). DNA microarrays containing oligonucleotides designed to interrogate each individual nucleotide of a nucleic acid sequence (resequencing arrays) have been applied to viral genes (Kozal et al., 1996, Nature Medicine 2:753-758), human genes (Pollack et al., 2002, Proc Natl Acad Sci 99:12963), and whole genomes (Gresham et al., 2006, Science 311:1931-1936). Fast and reliable hybridization-based polymorphism detection assays have been developed (See Wang, et al., 1998, Science 280:1077-1082; Gingeras, et al., 1998, Genome Research 8:435-448; Halushka, et al., 1999, Nature Genetics 22:239-247; Cutler et al., 2001, Genome Research 11(11):1913-25), all incorporated herein by reference in their entireties. However, the transition of these powerful techniques to regular clinical patient care has been slow.

An HIV-HCV microarray that rapidly and accurately provides the sequence of the genes that encode the proteins targeted by both approved and investigational anti-HIV and anti-HCV agents would greatly facilitate both in vitro and in vivo HIV and HCV drug resistance research and would greatly assist clinicians in individually tailoring antiviral therapy. Optimally tailored treatment regimens directed against particular drug resistant strains infecting particular patients requires an assay able to simultaneously identify all possible resistant variant strains of HIV and HCV, now matter how infrequently the particular strain is represented in the quasi-species population. The current invention fulfills this need.

### SUMMARY OF THE DISCLOSURE

The present invention contemplates an array of nucleic acid probes having at least four probe sets immobilized on a solid support. In the first probe set, each probe comprises a segment of at least fifteen nucleotides exactly complementary to a subsequence of a virus reference sequence. Each of the probes of the first probe set includes at least one interrogation position complementary to a corresponding nucleotide in the virus reference sequence. In the second, third and fourth probe sets, each probe comprises a corresponding probe for each probe in the first probe set, with the probes in the second, third and fourth probe sets being otherwise identical to the corresponding probe from the first probe set, or a subsequence of at least fifteen nucleotides thereof that includes the interrogation position, except that the interrogation position is occupied by a different nucleotide in each of the four corresponding probes from the four probe sets.

In another embodiment, the array of the present invention further comprises a fifth probe set comprising a probe for each interrogation position in the first probe set, each probe in the fifth probe set being identical to a sequence comprising a corresponding probe from the first probe set, or a subsequence of at least fifteen nucleotides thereof that includes the interrogation position, except that the interrogation position is deleted in the corresponding probe from the fifth probe set. In yet another embodiment, the array of the present invention further comprises a fifth probe set comprising a probe for each interrogation position in the first probe set, each probe in the fifth probe set being identical to a sequence comprising the corresponding probe from the first probe set, or a subsequence of at least fifteen nucleotides thereof that includes the interrogation position, except that an additional nucleotide is inserted adjacent to the single interrogation position in the corresponding probe from the first probe set.

In one aspect, the virus reference sequence comprises SEQ ID NOS:1, 2, 39, 60, 80-85, 94, 103-106 and 108-113. In another aspect, the virus reference sequence further comprises known drug resistance mutations comprising SEQ ID NOS:3-38, 40-59, 61-79, 86-93, 95-102 and 107.

In one embodiment, the invention contemplates a method of identifying a mutation in a viral gene sequence in a sample comprising hybridizing nucleic acid derived from the sample to the array of the invention and analyzing the hybridization pattern to estimate the sequence of the nucleic acid. In one aspect, the viral gene sequence is an HIV gene sequence. In another aspect, the viral gene sequence is an HCV gene sequence.

In another embodiment, the invention contemplates a method of evaluating the effectiveness of the antiviral drug therapy of a virus-infected patient comprising obtaining a sample from a virus-infected patient, and hybridizing nucleic acid derived from the sample to the array of the invention, and analyzing the hybridization pattern to estimate the sequence of the nucleic acid, and determining whether the sample comprises a nucleic acid having a mutation associated with resistance to an antiviral drug therapy. In one aspect, the virus-infected patient is infected with HIV. In another aspect, the virus-infected patient is infected with HCV. In yet another aspect, the virus-infected patient is infected with both HIV and HCV.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 depicts the results of an example assay demonstrating the detection of a low abundance sequence in a mixture of low-abundance and high-abundance sequences by hybridization of a mixture of target sequences (i.e., 1% codon 82T(ACC) and 99% codon 82V(GTC)) to an array of probes designed to detect the HIV protease codon 82A mutation. In the upper left panel, the “+” is on the G (probe content C) of GTC and in the upper right panel, the “+” is on A (probe content T), which represents A from target of ACC. The lower panels depict hybridization to the sense array from experiment shown in the upper panels. In the lower left panel, the “+” is on the T (probe content A) of GTC and in the lower right panel, the “+” is on C (probe content G), which represents C from target of ACC. Note that because there is no perfect match for wild-type within this array of probes, the intensities are not linear.

FIG. 2 depicts the results of an example assay demonstrating the detection of low-abundance viral variant in patient samples. (A) Standard sequencing reads (AAA-K) for RT codon 103, however a minor C peak is visible in an enlarged view of the trace file suggesting minor variant (AAC-N). (B) The standard oligonucleotide arrays for wild type sequence for this region also calls AAA-N for codon 103. However, the probes for AAC at codon 103 detect the AAC variant easily. Panel (C) shows when the software is set to call the best hybridization for mutation containing probes. Panel (D) shows when the software is set to detect a mixture of bases as the same mutation containing probes. (E) Photon intensities for each of the probes of the set of 8 probes for the mutation at the third position of RT codon 103. The 25-mer probe for base C has the highest intensity because the quantity of minor variant (AAC) hybridized to the microarray after PCR amplification was sufficient to hybridize to a high proportion of mutant probes even though the AAA variant is dominant (by ABI sequencing) which has the next highest intensity value.

FIG. 3 depicts the results of an example assay demonstrating the detection of mutations of HIV integrase in patient samples. In this example assay, the array detected target sequences having synonymous polymorphisms at Integrase codons Q148 (caa) and N155 (aat) by hybridization to probes based on consensus Integrase sequence (both aat and caa code for Asparagine (N)).

FIG. 4 depicts the results of an example assay demonstrating the detection of mutations of HCV NS3 and NS5B in patient samples.

FIG. 5, comprising 5A-5L, depicts a table listing virus reference sequences.

### DETAILED DESCRIPTION OF THE INVENTION

The invention features a nucleotide array able to simultaneously detect HIV and HCV mutations associated with drug resistance. The invention is used to identify and characterize drug resistant strains of HIV and HCV. In one aspect, viral nucleic acid is isolated from individuals potentially carrying a drug resistant strain of the virus and the methods and compositions of the invention are used to identify polymorphisms characteristic of the isolate. In addition, viral nucleic acid can be isolated from individuals suspected or known to be infected with HIV or HCV, or both, and a resequencing array is used to identify polymorphisms that are known to be associated with resistance to antiviral drug therapy, or novel polymorphisms not yet known to be associated with resistance to antiviral drug therapy. Also, viral nucleic acid may be isolated from individuals known to be infected with HIV or HCV, or both, and a resequencing array may be used to monitor and quantitate changing levels of the polymorphic strain within the virus population infecting the individual.

Variations occur in the nucleotide sequences of HIV and HCV viruses. As with many viruses, mutation allows the virus to defeat the host's defenses and confer resistance to antiviral therapy. It is therefore important to identify mutations in these viruses and to correlate them with clinical phenotypes. Mutations may also be responsible for differences in pathogenicity and infectivity, giving rise to an additional need to be able to detect such mutations. The compositions and methods presently disclosed may be used to rapidly identify mutations in a sample by comparing that sequence to a reference sequence. The sample is hybridized to an array of probes. The array of probes comprises the entire sequence of the set of reference sequences tiled so that there is a probe to interrogate each position of the sequence for each possible single nucleotide substitution (see U.S. Pat. Nos. 5,837,832 and 5,861,242 which are incorporated herein by reference). The array of probes additionally comprises a set of reference sequences of known mutations of HIV and HCV associated with resistance to antiviral therapy.

In one aspect, the invention is a nucleotide array able to detect drug resistant viral variants, even when they make up only a minor fraction (for example roughly 1%) of the circulating HIV and HCV quasi-species population in a patient sample. In another aspect, the nucleotide array detects low frequency (for example about 1%) mutant strains of HIV and HCV infecting a patient, enabling clinicians to optimally tailor anti-viral therapy for particular patients with the best antiviral regimens for a particular resistant strain or combination of resistant strains.

In another aspect, the invention is a nucleotide array that simultaneously detects the sequence of the HIV protease, HIV RT, and HIV integrase genes, as well as the HCV NS3, HCV NS4A, HCV NS4B, HCV NS5A and HCV NS5B genes. The nucleotide array is able to simultaneously detect the sequence of the HIV protease, HIV RT, and HIV integrase genes from, but not limited to, the HIV clades A1, A2, B, C, D, F1, F2, G, H, J and K, as well as the HCV NS3, HCV NS4A, HCV NS4B, HCV NS5A and HCV NS5B genes from, but not limited to, the HCV genotypes 1a, 1b, 1c, 2a, 2b, 2c, 3a, 3b, 4a, 4b, 4c, 4d, 4e, 5a, 6a, 7a, 7b, 8a, 8b, 9a, 10a, and 11a.

The invention provides an array of nucleic acid probes immobilized on a solid support for analysis of a target sequence from a HIV and HCV virus. The resequencing array may be designed to resequence an entire genome, such as the genome of the HIV virus or the HCV virus; or one or more regions of a genome, for example, selected regions of a genome such as those coding for a protein or RNA of interest; or a conserved region from multiple genomes; or multiple genomes, such as the genome of a first HIV isolate and the genome of a second HIV isolate, or the genome of a first HCV isolate and the genome of a second HCV isolate, or the genome of HIV and the genome of HCV, or combinations thereof. Resequencing arrays and methods of genetic analysis using resequencing arrays is described in Cutler, et al., 2001, Genome Res. 11(11): 1913-1925 and Warrington, et al., 2002, Hum Mutat 19:402-409 and in US Patent Pub No 20030124539, each of which is incorporated herein by reference in its entirety.

In one embodiment, the invention is a method of monitoring the sequences of viral isolates from the same or from different individuals. In another embodiment, the invention involves resequencing a viral isolate on a resequencing array and comparing the sequence of the isolate to one or more other sequences. In another embodiment, the frequency of a particular mutation is determined. A particular mutation or mutations may be associated with a phenotype, for example, a drug resistant phenotype.

In one embodiment, the invention is a nucleotide array for resequencing an isolate of HIV or HCV or both HIV and HCV. The array may comprise one or more probes corresponding to SEQ ID NOS:1-113. In one embodiment, the array comprises probes corresponding to each of the sequences in SEQ ID NOS:1-113 and may in addition comprise a collection of control probes.

A resequencing array, according to the present invention, has probes to reference sequences from both HIV and HCV viruses tiled so that each nucleic acid position in the reference sequence is interrogated by a probe set of at least four perfect match probes. Each of the four probes is a perfect match to a different sequence and the sequences differ at the interrogation position, which is typically the central base of the probe. For example, nucleotide 13 in a 25 nucleotide probe. The first probe of the four probes is perfectly complementary to the reference sequence and each of the remaining three probes is perfectly complementary to a different single base mutation at the interrogation position so that at least one probe of the four probes is perfectly complementary to each of the four possible bases present at the interrogation position.

In one embodiment, the invention provides an array of oligonucleotide probes immobilized on a solid support for analysis of a target sequence of genes of both HIV and HCV. The array comprises at least four sets of oligonucleotide probes 15 to 35 nucleotides in length. In one embodiment, the probes are 25 nucleotides in length. A first probe set has a probe corresponding to each nucleotide in the reference sequences SEQ ID NOS:1-113. A probe is related to its corresponding nucleotide by being exactly complementary to a subsequence of the reference sequence that includes the corresponding nucleotide. Thus, each probe has a position, designated an interrogation position, that is occupied by a complementary nucleotide to the corresponding nucleotide. The three additional probe sets each have a corresponding probe for each probe in the first probe set. Thus, for each nucleotide in the reference sequence, there are four corresponding probes, one from each of the probe sets. The three corresponding probes in the three additional probe sets are identical to the corresponding probe from the first probe or a subsequence thereof that includes the interrogation position, except that the interrogation position is occupied by a different nucleotide in each of the four corresponding probes. For example, if the interrogation position has a G in the reference sample there will be a reference probe with a C that is perfectly complementary to the reference sequence, a non-reference probe with an A, a non-reference probe with a G and a non-reference probe with a T at that position, the latter three probes being complementary to mutation at that position to T, C and A respectively. If the interrogation position is mutated, hybridization will occur at one of the non-reference probes. Both strands (for example, sense and anti-sense) of the sequence may be tiled on an array in this manner to detect a mutation on either or both strands.

In another embodiment, the array comprises at least eight sets of oligonucleotide probes 15-35 nucleotides in length. In one embodiment, the probes are at least 25 nucleotides in length. The probes are present in sets of eight probes that are related. A first probe set comprises a sequence corresponding to each nucleotide in the reference sequences SEQ ID NOS:1-113. A second probe set is the complement of the first probe set. This way both strands are analyzed. Three of the remaining six probe sets are identical to the first probe set except for a single nucleotide in each probe, the interrogation position, which is varied so that each of the possible four bases is represented at the interrogation position in each probe of the set. The remaining three probe sets are identical to the second probe set except for a single nucleotide in each probe, the interrogation position, which is varied so that each of the possible four bases is represented at the interrogation position in each probe of the set. For example, if the interrogation position has a G in the reference sample there will be a reference probe with a C that is perfectly complementary to the reference sequence, a non-reference probe with an A, a non-reference probe with a G and a non-reference probe with a T at that position, the latter three probes being complementary to mutation at that position to T, C and A respectively. If the interrogation position is mutated, hybridization will occur at one of the non-reference probes.

In one embodiment, the target sequence has a substituted nucleotide relative to the reference sequence in at least one position, and the relative specific binding of the probes indicates the location of the position and the nucleotide occupying the position in the target sequence. In some applications the target sequence has a substituted nucleotide relative to the reference sequence in at least one position, the substitution associated with drug resistance to the HIV or the HCV virus, and the relative specific binding of the probes reveals the substitution.

In one embodiment, the array additionally comprises probes with sequences containing known HIV and HCV mutations. In one aspect, the addition of probes containing known mutations serves to improve detection and quantification of the known mutation. In another aspect, the addition of probes containing known mutations serves to improve mutation detection and quantification of other mutations occurring within the probe sequence adjacent to the known mutation.

In another embodiment, the array additionally comprises an alternate tiling of probes with sequences containing known HIV and HCV mutations. In one aspect, the alternate tiling of probes containing known mutations serves to improve detection and quantification of the known mutation. In another aspect, the alternate tiling of probes containing known mutations serves to improve mutation detection and quantification of other mutations occurring within the probe sequence adjacent to the known mutation.

In some embodiments, the methods disclosed eliminate any need to culture the virus outside of the host prior to sequencing. Mutations can accumulate while the virus is being cultured for sequencing. These mutations may be adaptations to laboratory culture and may not have been present in the virus isolated from the patient. Direct analysis of the virus without laboratory cell culture may be performed using the methods presently disclosed. Viral nucleic acid may be isolated from the host, amplified and analyzed on a resequencing array without the need for cell culture.

Early sequence monitoring of many isolates in parallel may be used to rapidly identify isolates and mutations. Some isolates of a given virus may have more severe phenotypes than other isolates, for example, higher levels of morbidity or mortality rates and drug resistance.

A database of viral sequences may be developed, according to the invention. Resequencing analysis in combination with high throughput methods may be used to generate sequence variation information from a large number of viral isolates, from a large number of individuals, or from the same individual over time. The sequence variation information may be used to generate a database of sequence variation information. The sequence variation information may be coupled to additional information, for example, information about the geographic location where the sample was isolated, clinical information about the patient such as duration of illness, effectiveness of treatment, morbidity, mortality, and degree of transmission and biographical information about the patient, for example, age, gender, health, and other socioeconomic facts.

Gene sequences from both HIV and HCV may be tiled on a single array. Regions of a virus known to be associated with drug resistance may also be tiled on a resequencing array. Further, mutated regions of a virus known to confer drug resistance may be tiled on a resequencing array. Viral isolates from clinical samples may be resequenced to identify a mutation and then the mutation may be correlated with phenotypes such as drug resistance to a particular drug, severity of illness, increased risk of mortality, increased risk of transmission, etc. This information may be used to select, alter, or optimize an antiviral treatment for a particular patient.

Arrays may be packaged in such a manner as to allow for diagnostic use or can be an all-inclusive device; e.g., U.S. Pat. Nos. 5,856,174 and 5,922,591 incorporated in their entirety by reference for all purposes. Arrays are commercially available from Affymetrix (Santa Clara, Calif.) under the brand name GeneChip® and are directed to a variety of purposes, including genotyping, diagnostics, mutation analysis, and gene expression monitoring for a variety of eukaryotic, prokaryotic, and viral organisms. The number of probes on a solid support may be varied by changing the size of the individual features. In one embodiment the feature size is 20 by 25 microns square, in other embodiments features may be, for example, 8 by 8, 5 by 5 or 3 by 3 microns square, resulting in about 2,600,000, 6,600,000 or 18,000,000 individual probe features.

The practice of the present invention may employ, unless otherwise indicated, conventional techniques and descriptions of organic chemistry, polymer technology, molecular biology (including recombinant techniques), cell biology, biochemistry, and immunology, which are within the skill in the art. Such conventional techniques include polymer array synthesis, hybridization, ligation, and detection of hybridization using a label. Specific illustrations of suitable techniques can be had by reference to the examples disclosed elsewhere herein. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press); Stryer, L., 1995, Biochemistry (4th Ed.) Freeman, New York; Gait, 1984, “Oligonucleotide Synthesis: A Practical Approach,” IRL Press, London, Nelson and Cox; Lehninger, Principles of Biochemistry 3rd Ed., W.H. Freeman Pub., New York, N.Y.; and Berg et al., 2002, Biochemistry, 5th Ed., W.H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos PCT/US99/00730 (International Publication No WO 99/36760) and PCT/US01/04285 (International Publication No WO 01/58593), which are all incorporated herein by reference in their entirety for all purposes.

Patents that describe synthesis techniques in specific embodiments include U.S. Pat. Nos. 5,412,087, 6,153,743, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at www.affymetrix.com. Arrays are disclosed in U.S. Pat. No. 6,610,482.

The present invention also contemplates many uses for polymers attached to solid substrates. These uses include gene expression monitoring, profiling, library screening, genotyping, mutation analysis, and diagnostics. Gene expression monitoring and profiling methods are described in U.S. Pat. Nos. 5,800,992, 6,013,449, 6,020,135, 6,033,860, 6,040,138, 6,177,248 and 6,309,822. Genotyping and uses therefore are shown in U.S. Ser. No. 10/442,021 and U.S. Pat. Nos. 5,856,092, 6,300,063, 5,858,659, 6,284,460, 6,361,947, 6,368,799, 6,333,179 and 6,872,529. Other uses are embodied in U.S. Pat. Nos. 5,871,928, 5,902,723, 6,045,996, 5,541,061, and 6,197,506.

The present invention further contemplates sample preparation methods in certain embodiments. Prior to or concurrent with genotyping, the genomic sample may be amplified by a variety of mechanisms, some of which may employ PCR. For example, primers for long range PCR may be designed to amplify regions of the sequence. For RNA viruses a first reverse transcriptase step may be used to generate double stranded DNA from the single stranded RNA. See, for example, PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, each of which is incorporated herein by reference in their entirety for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (for example, Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed PCR (CP-PCR) (U.S. Pat. No. 4,437,975), arbitrarily primed PCR (AP-PCR) (U.S. Pat. Nos. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (US Patent Application Publication 20030096235), 09/910,292 (US Patent Application Publication 20030082543), and Ser. No. 10/013,598.

Methods for conducting polynucleotide hybridization assays have been developed in the art. Hybridization assay procedures and conditions will vary depending on the application and are selected in accordance with the general binding methods known including those referred to in: Maniatis et al. Molecular Cloning: A Laboratory Manual (2.sup.nd Ed. Cold Spring Harbor, N.Y, 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference.

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 10/389,194 and in PCT Application PCT/US99/06097 (published as WO99/47964), each of which also is hereby incorporated by reference in its entirety for all purposes. In one embodiment, pairs are present in perfect match and mismatch pairs, one probe in each pair being a perfect match to the target sequence and the other probe being identical to the perfect match probe except that the central base is a homo-mismatch. Mismatch probes provide a control for non-specific binding or cross-hybridization to a nucleic acid in the sample other than the target to which the probe is directed. Thus, mismatch probes indicate whether hybridization is or is not specific. For example, if the target is present, the perfect match probes should be consistently brighter than the mismatch probes because fluorescence intensity, or brightness, corresponds to binding affinity. (See e.g., U.S. Pat. No. 5,324,633, which is incorporated herein for all purposes.) Finally, the difference in intensity between the perfect match and the mismatch probe (I(PM)-I(MM)) provides a good measure of the concentration of the hybridized material. See PCT No WO 98/11223, which is incorporated herein by reference for all purposes.

In one embodiment, the hybridized nucleic acids are detected by detecting one or more labels attached to the sample nucleic acids. The labels may be incorporated by any of a number of means well known to those of skill in the art. In one embodiment, the label is simultaneously incorporated during the amplification step in the preparation of the sample nucleic acids. Thus, for example, PCR with labeled primers or labeled nucleotides will provide a labeled amplification product. In another embodiment, transcription amplification, as described above, using a labeled nucleotide (e.g. fluorescein-labeled UTP and/or CTP) incorporates a label into the transcribed nucleic acids. In another embodiment PCR amplification products are fragmented and labeled by terminal deoxytransferase and labeled dNTPs. Alternatively, a label may be added directly to the original nucleic acid sample (e.g., mRNA, polyA mRNA, cDNA, etc.) or to the amplification product after the amplification is completed. Means of attaching labels to nucleic acids are well known to those of skill in the art and include, for example, nick translation or end-labeling (e.g. with a labeled RNA) by kinasing the nucleic acid and subsequent attachment (ligation) of a nucleic acid linker joining the sample nucleic acid to a label (e.g., a fluorophore). In another embodiment label is added to the end of fragments using terminal deoxytransferase.

Detectable labels suitable for use in the present invention include any composition detectable by spectroscopic, photochemical, biochemical, immunochemical, electrical, optical or chemical means. Useful labels in the present invention include, but are not limited to: biotin for staining with labeled streptavidin conjugate; anti-biotin antibodies, magnetic beads (e.g., Dynabeads™); fluorescent dyes (e.g., fluorescein, texas red, rhodamine, green fluorescent protein, and the like); radiolabels (e.g., .sup.3H, .sup.125I, .sup.35S, .sup.4C, or .sup.32P); phosphorescent labels; enzymes (e.g., horse radish peroxidase, alkaline phosphatase and others commonly used in an ELISA); and colorimetric labels such as colloidal gold or colored glass or plastic (e.g., polystyrene, polypropylene, latex, etc.) beads. Patents teaching the use of such labels include U.S. Pat. Nos. 3,817,837, 3,850,752, 3,939,350, 3,996,345, 4,277,437, 4,275,149 and 4,366,241, each of which is hereby incorporated by reference in its entirety for all purposes.

Means of detecting such labels are well known to those of skill in the art. Thus, for example, radiolabels may be detected using photographic film or scintillation counters; fluorescent markers may be detected using a photodetector to detect emitted light. Enzymatic labels are typically detected by providing the enzyme with a substrate and detecting the reaction product produced by the action of the enzyme on the substrate, and calorimetric labels are detected by simply visualizing the colored label.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, for example Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2.sup.nd ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170. Additionally, the present invention may have preferred embodiments that include methods for providing genetic information over networks such as the Internet as shown in U.S. Ser. Nos. 10/197,621, 10/063,559 (US Pub No 20020183936), 10/065,856, 10/065,868, 10/328,818, 10/328,872, 10/423,403, and 60/482,389.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

U.S. Pat. Nos. 5,800,992 and 6,040,138 describe methods for making arrays of nucleic acid probes that can be used to detect the presence of a nucleic acid containing a specific nucleotide sequence. Methods of forming high-density arrays of nucleic acids, peptides and other polymer sequences with a minimal number of synthetic steps are known. The nucleic acid array can be synthesized on a solid substrate by a variety of methods, including, but not limited to, light-directed chemical coupling, and mechanically directed coupling. For additional descriptions and methods relating to resequencing arrays see U.S. patent application Ser. Nos. 10/658,879, 60/417,190, 09/381,480, 60/409,396, U.S. Pat. Nos. 5,861,242, 6,027,880, 5,837,832, 6,723,503 and PCT Pub No 03/060526 each of which is incorporated herein by reference in its entirety.

### DEFINITIONS

The articles “a” and “an” are used herein to refer to one or to more than one (i.e. to at least one) of the grammatical object of the article. By way of example, “an element” means one element or more than one element.

As used herein, “individual” is not limited to a human being but may also be other organisms including but not limited to mammals, plants, bacteria, or viruses.

As used herein, “isolate” refers to a viral sequence obtained from an individual, or from a sample obtained from an individual. The viral sequence may be analyzed at any time after it is obtained (e.g., before or after laboratory culture, before or after amplification.)

As used herein, “homologous” refers to the subunit sequence similarity between two polymeric molecules, e.g., between two nucleic acid molecules, e.g., two DNA molecules or two RNA molecules, or between two polypeptide molecules. When a subunit position in both of the two molecules is occupied by the same monomeric subunit, e.g., if a position in each of two DNA molecules is occupied by adenine, then they are homologous at that position. The homology between two sequences is a direct function of the number of matching or homologous positions, e.g., if half (e.g., five positions in a polymer ten subunits in length) of the positions in two compound sequences are homologous then the two sequences are 50% homologous, if 90% of the positions, e.g., 9 of 10, are matched or homologous, the two sequences share 90% homology. By way of example, the DNA sequences 3′ATTGCC5′ and 3′TATGGC share 50% homology.

As used herein, “homology” is used synonymously with “identity.” In addition, when the term “homology” is used herein to refer to the nucleic acids and proteins, it should be construed to be applied to homology at both the nucleic acid and the amino acid levels. The determination of percent identity between two nucleotide or amino acid sequences can be accomplished using a mathematical algorithm. For example, a mathematical algorithm useful for comparing two sequences is the algorithm of Karlin and Altschul (1990, Proc. Natl. Acad. Sci. USA 87:2264-2268), modified as in Karlin and Altschul (1993, Proc. Natl. Acad. Sci. USA 90:5873-5877). This algorithm is incorporated into the NBLAST and XBLAST programs of Altschul, et al. (1990, J. Mol. Biol. 215:403-410), and can be accessed, for example, at the National Center for Biotechnology Information (NCBI) world wide web site having the universal resource locator www<dot>ncbi<dot>nlm<dot>nih<dot>gov/BLAST/. BLAST nucleotide searches can be performed with the NBLAST program (designated “blastn” at the NCBI web site), using the following parameters: gap penalty=5; gap extension penalty=2; mismatch penalty=3; match reward=1; expectation value 10.0; and word size=11 to obtain nucleotide sequences homologous to a nucleic acid described herein. BLAST protein searches can be performed with the XBLAST program (designated “blastn” at the NCBI web site) or the NCBI “blastp” program, using the following parameters: expectation value 10.0, BLOSUM62 scoring matrix to obtain amino acid sequences homologous to a protein molecule described herein.

To obtain gapped alignments for comparison purposes, Gapped BLAST can be utilized as described in Altschul et al. (1997, Nucleic Acids Res. 25:3389-3402). Alternatively, PSI-Blast or PHI-Blast can be used to perform an iterated search which detects distant relationships between molecules (id.) and relationships between molecules which share a common pattern. When utilizing BLAST, Gapped BLAST, PSI-Blast, and PHI-Blast programs, the default parameters of the respective programs (e.g., XBLAST and NBLAST) can be used. See www<dot>ncbi<dot>nlm<dot>nih<dot>gov. The percent identity between two sequences can be determined using techniques similar to those described above, with or without allowing gaps. In calculating percent identity, typically exact matches are counted.

As used herein a “probe” is defined as a nucleic acid capable of binding to a target nucleic acid of complementary sequence through one or more types of chemical bonds, usually through complementary base pairing, usually through hydrogen bond formation. As used herein, a probe may include natural (i.e. A, G, U, C, or T) or modified bases (7-deazaguanosine, inosine, etc.). In addition, a linkage other than a phosphodiester bond may join the bases in probes, so long as it does not interfere with hybridization. Thus, probes may be peptide nucleic acids in which the constituent bases are joined by peptide bonds rather than phosphodiester linkages.

The term “match,” “perfect match,” “perfect match probe” or “perfect match control” refers to a nucleic acid that has a sequence that is perfectly complementary to a particular target sequence. The nucleic acid is typically perfectly complementary to a portion (subsequence) of the target sequence. A perfect match (PM) probe can be a “test probe”, a “normalization control” probe, an expression level control probe and the like. A perfect match control or perfect match is, however, distinguished from a “mismatch” or “mismatch probe.”

The term “mismatch,” “mismatch control” or “mismatch probe” refers to a nucleic acid whose sequence is not perfectly complementary to a particular target sequence. As a non-limiting example, for each mismatch (MM) control in a high-density probe array there typically exists a corresponding perfect match (PM) probe that is perfectly complementary to the same particular target sequence. The mismatch may comprise one or more bases. While the mismatch(es) may be located anywhere in the mismatch probe, terminal mismatches are less desirable because a terminal mismatch is less likely to prevent hybridization of the target sequence. In a particularly preferred embodiment, the mismatch is located at or near the center of the probe such that the mismatch is most likely to destabilize the duplex with the target sequence under the test hybridization conditions.

A “homo-mismatch” substitutes an adenine (A) for a thymine (T) and vice versa and a guanine (G) for a cytosine (C) and vice versa. For example, if the target sequence was: AGGTCCA, a probe designed with a single homo-mismatch at the central, or fourth position, would result in the following sequence: TCCTGGT.

Nucleic acids according to the present invention may include any polymer or oligomer of pyrimidine and purine bases, preferably cytosine, thymine, and uracil, and adenine and guanine, respectively. (See Albert L. Lehninger, Principles of Biochemistry, at 793-800 (Worth Pub. 1982) which is herein incorporated in its entirety for all purposes). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

An “oligonucleotide” or “polynucleotide” is a nucleic acid ranging from at least 2, preferably at least 8, 15 or 25 nucleotides in length, but may be up to 50, 100, 1000, or 5000 nucleotides long or a compound that specifically hybridizes to a polynucleotide. Polynucleotides of the present invention include sequences of deoxyribonucleic acid (DNA) or ribonucleic acid (RNA) or mimetics thereof which may be isolated from natural sources, recombinantly produced or artificially synthesized. A further example of a polynucleotide of the present invention may be a peptide nucleic acid (PNA). (See U.S. Pat. No. 6,156,501 which is hereby incorporated by reference in its entirety.) The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this disclosure.

A “genome” is all the genetic material of an organism. The term genome may refer to genetic materials from organisms that have or that do not have chromosomal structure. In addition, the term genome may refer to mitochondria DNA. A genomic library is a collection of DNA fragments representing the whole or a portion of a genome. Frequently, a genomic library is a collection of clones made from a set of randomly generated, sometimes overlapping DNA fragments representing the entire genome or a portion of the genome of an organism.

An “allele” refers to one specific form of a genetic sequence (such as a gene) within a cell, an individual or within a population, the specific form differing from other forms of the same gene in the sequence of at least one, and frequently more than one, variant sites within the sequence of the gene. The sequences at these variant sites that differ between different alleles are termed “variants,” “polymorphisms,” or “mutations.”

Polymorphism refers to the occurrence of two or more genetically determined alternative sequences or alleles in a population. A polymorphic marker or site is the locus at which divergence occurs. A polymorphism may comprise one or more base changes, an insertion, a repeat, or a deletion. A polymorphic locus may be as small as one base pair. The first identified allelic form is arbitrarily designated as the reference form and other allelic forms are designated as alternative or variant alleles. The allelic form occurring most frequently in a selected population is sometimes referred to as the wildtype form. A diallelic polymorphism has two forms. A triallelic polymorphism has three forms. A polymorphism between two nucleic acids can occur naturally, or be caused by exposure to or contact with chemicals, enzymes, or other agents, or exposure to agents that cause damage to nucleic acids, for example, ultraviolet radiation, mutagens or carcinogens.

Single nucleotide polymorphisms (SNPs) are positions at which two alternative bases occur at appreciable frequency (about at least 1%) in a given population. A SNP may arise due to substitution of one nucleotide for another at the polymorphic site. A transition is the replacement of one purine by another purine or one pyrimidine by another pyrimidine. A transversion is the replacement of a purine by a pyrimidine or vice versa. SNPs can also arise from a deletion of a nucleotide or an insertion of a nucleotide relative to a reference allele.

The term “genotyping” refers to the determination of the genetic information an individual carries at one or more positions in the genome. For example, genotyping may comprise the determination of which allele or alleles an individual carries for a single SNP or the determination of which allele or alleles an individual carries for a plurality of SNPs. For example, a particular nucleotide in a genome may be an A in some individuals and a C in other individuals. Those individuals who have an A at the position have the A allele and those who have a C have the C allele. A polymorphic location may have two or more possible alleles and the array may be designed to distinguish between all possible combinations.

An “array” comprises a support, preferably solid, with nucleic acid probes attached to the support. Preferred arrays typically comprise a plurality of different nucleic acid probes that are coupled to a surface of a substrate in different, known locations. These arrays, also described as “microarrays” or colloquially “chips” have been generally described in the art, for example, U.S. Pat. Nos. 5,143,854, 5,445,934, 5,744,305, 5,677,195, 5,800,992, 6,040,193, 5,424,186 and Fodor et al., 1991, Science, 251:767-777, each of which is incorporated by reference in its entirety for all purposes. Arrays may generally be produced using a variety of techniques, such as mechanical synthesis methods or light directed synthesis methods that incorporate a combination of photolithographic methods and solid phase synthesis methods. Techniques for the synthesis of these arrays using mechanical synthesis methods are described in, e.g., U.S. Pat. Nos. 5,384,261, and 6,040,193, which are incorporated herein by reference in their entirety for all purposes. Although a planar array surface is preferred, the array may be fabricated on a surface of virtually any shape or even a multiplicity of surfaces. Arrays may be nucleic acids on beads, gels, polymeric surfaces, fibers such as fiber optics, glass or any other appropriate substrate. (See U.S. Pat. Nos. 5,770,358, 5,789,162, 5,708,153, 6,040,193 and 5,800,992, which are hereby incorporated by reference in their entirety for all purposes.)

A “resequencing array” is an array of nucleic acid probes with four probes tiled for both the forward and reverse strand (sense and antisense strand) for each individual base in a sequence. The central position of each probe varies to incorporate each of the four possible nucleotides, A, C, G or T. See, GeneChip CustomSeq Resequencing Arrays Data Sheet, available from Affymetrix, Inc. part no. 701225 Rev. 3. Arrays are designed based on the sequence to be resequenced. A known sequence is selected and the array is designed using that sequence as a reference sequence.

Hybridization probes are oligonucleotides capable of binding in a base-specific manner to a complementary strand of nucleic acid. Such probes include peptide nucleic acids, as described in Nielsen et al., 1991, Science 254, 1497-1500, and other nucleic acid analogs and nucleic acid mimetics. See U.S. Pat. No. 6,156,501.

The term “hybridization” refers to the process in which two single-stranded nucleic acids bind non-covalently to form a double-stranded nucleic acid; triple-stranded hybridization is also theoretically possible. Complementary sequences in the nucleic acids pair with each other to form a double helix. The resulting double-stranded nucleic acid is a “hybrid.”Hybridization may be between, for example tow complementary or partially complementary sequences. The hybrid may have double-stranded regions and single stranded regions. The hybrid may be, for example, DNA:DNA, RNA:DNA or DNA:RNA. Hybrids may also be formed between modified nucleic acids. One or both of the nucleic acids may be immobilized on a solid support. Hybridization techniques may be used to detect and isolate specific sequences, measure homology, or define other characteristics of one or both strands.

The stability of a hybrid depends on a variety of factors including the length of complementarity, the presence of mismatches within the complementary region, the temperature and the concentration of salt in the reaction. Hybridizations are usually performed under stringent conditions, for example, at a salt concentration of no more than 1 M and a temperature of at least 25.degree. C. For example, conditions of 5.times.SSPE (750 mM NaC1, 50 mM Na Phosphate, 5 mM EDTA, pH 7.4) or 100 mM MES, 1 M Na, 20 mM EDTA, 0.01% Tween-20 and a temperature of 25-50.degree. C. are suitable for allele-specific probe hybridizations. In a particularly preferred embodiment, hybridizations are performed at 40-50.degree. C. Acetylated BSA and herring sperm DNA may be added to hybridization reactions. Hybridization conditions suitable for microarrays are described in the Gene Expression Technical Manual and the GeneChip Mapping Assay Manual available from Affymetrix (Santa Clara, Calif.).

The term “label” as used herein refers to a luminescent label, a light scattering label or a radioactive label. Fluorescent labels include, but are not limited to, the commercially available fluorescein phosphoramidites such as Fluoreprime (Pharmacia), Fluoredite (Millipore) and FAM (ABI). See U.S. Pat. No. 6,287,778.

The term “solid support”, “support”, and “substrate” as used herein are used interchangeably and refer to a material or group of materials having a rigid or semi-rigid surface or surfaces. In one embodiment, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, oligonucleotides, nucleic acids, antibodies, cell membrane receptors, monoclonal antibodies and antisera reactive with specific antigenic determinants (such as on viruses, cells or other materials), drugs, peptides, cofactors, lectins, sugars, polysaccharides, cells, cellular membranes, and organelles. Targets are sometimes referred to in the art as anti-probes. As the term targets is used herein, no difference in meaning is intended.

A “probe target pair” is formed when two macromolecules have combined through molecular recognition to form a complex.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

The materials and methods used in the experimental examples are now described.

### Example 1

### HIV and HCV Microarray

To interrogate sequences of HIV and HCV, an array was designed according to the instructions in the GeneChip® CustomSeq® Custom Resequencing Array Design Guide (part number 701263 Rev. 4 available from Affymetrix, Santa Clara, Calif.). The array has features that are 8.times.8 microns in size. The array design comprises 25-nucleotide nucleic acid subsequences derived from the sequences depicted by SEQ ID NOS:1-113.

### Example 2

### Detection of Low Abundance Viral Sequence in a Mixture of Low-Abundance and High-Abundance Sequences

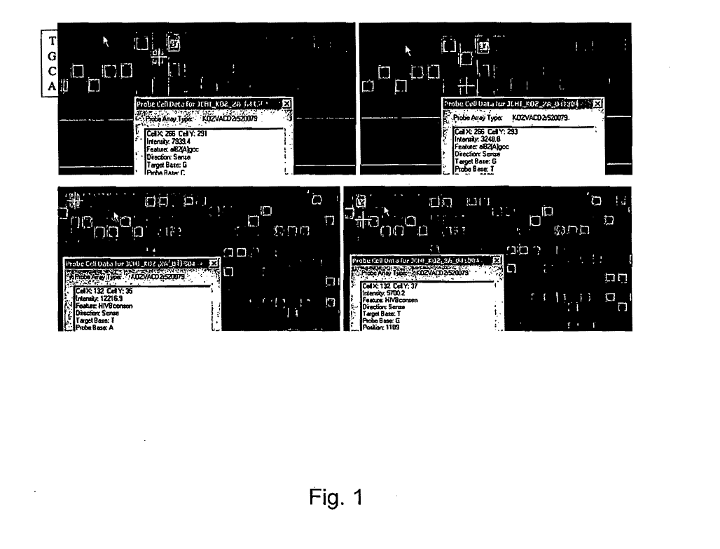

The array described in Example 1 was used to detect infrequently represented variants in a mixture of viral variants. PCR amplicons were generated from a DNA template containing the wild type HIV protease sequence and a DNA template containing a HIV protease sequence with a mutation at codon 82 (Taq DNA Polymerase; primer 1—CAGAGCAGACCA GAGCCAAC (SEQ ID NO:114); primer 2—AATGCTTTTATTTTTTCTTCTGTCAATGGC (SEQ ID NO: 115); 35 cycles 94.degree.C. for 30 sec, 50.degree.C. for 30 sec, 72.degree.C. for 60 sec; 1 cycle 72.degree.C. for 10 min; see also Nguyen, 2003, Aids Research and Human Retroviruses, 19:925-928). PCR amplicons were used to create a mixture of amplicons containing 99% of the wild type HW protease sequence and 1% of the mutant protease sequence having a mutation at codon 82. The mixture of PCR amplicons was hybridized to the array according to the manufacturer's instructions (see GeneChip® CustomSeq® Resequencing Array Protocol, part number 701231 Rev. 5 available from Affymetrix, Santa Clara, Calif.). Sequences were imported into Gene Chip Operating System and analyzed using Gene Chip Sequence Analysis software to detect polymorphisms based on hybridization intensities (Affymetrix, Santa Clara, Calif.). When sufficient PCR product containing a high-abundance variant and a low-abundance variant was applied to the array, the portion of products from the low-abundance mutant variant easily hybridize to the mutant probes and allows detection. FIG. 1 depicts the results of an assay demonstrating the array's ability to detect both sequences in a mixture of a low-abundance (1%) and high abundance (99%) HIV sequences. The probe area interrogating the mutation hybridizes with the input sample and yields enough photon intensity to be detected. In FIG. 1, the hybridization intensities of individual probe cell locations representing sense A, C, G, and T nucleotides at each position of the interrogated sequence for known HIV mutations, known to be associated with drug resistance, were analyzed. Probe arrays designed for protease codon 82 demonstrate how minor variants constituting only 1% of the entire viral population can be detected by the array. Although this experimental example demonstrates the sensitivity using only one known mutation, one with skill in the art will appreciate that these same detection levels are possible for any mutation of both HIV and HCV. Early detection of emerging resistant variants will enable patients and their clinicians to more quickly modify the patient's antiviral therapy so that emerging viral variants are less able to increase in frequency.

### Example 3

### Detection of Low-Abundance Viral Variant in Patient Samples

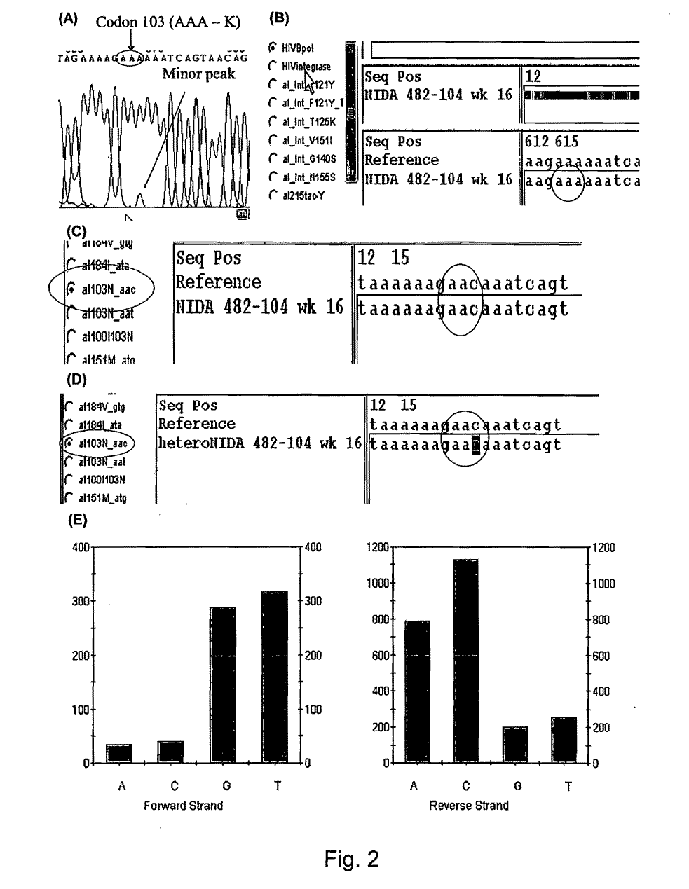

Samples collected from 20 anti-retroviral therapy (ART)-experienced patients were analyzed using the nucleic acid array described in Example 1. Patient samples were collected at baseline and after about 12 weeks of treatment. Viral RNA was extracted from patient samples using QIAamp viral RNA extraction kit (QIAGEN Sciences, Germantown, Md.) and used as template in two-round RT-PCR (First Round: SuperScript II RT-TAQ Mix; primer 1—TTGGAAATGTGGAAAGGA (SEQ ID NO:116); primer 2—CCTAGTGGGATGTGTACT (SEQ ID NO:117); 1 cycle 48.degree.C. for 30 min, 94.degree.C. for 2 min; 35 cycles 94.degree.C. for 30 sec, 50.degree.C. for 30 sec, 72.degree.C. for 60 sec; 1 cycle 72.degree.C. for 10 min; Second Round Taq DNA Polymerase; primer 1—TTGGTTGCACTITAAATMCCCAT™ AGTCCTATT (SEQ ID NO:118); primer 2—CCTACTAACTTCTGTATTCATTGACAGTC (SEQ ID NO:119); 35 cycles 94.degree.C. for 30 sec, 50.degree.C. for 30 sec, 72.degree.C. for 60 sec; 1 cycle 72.degree.C. for 10 min; see also Nguyen, 2003, Aids Research and Human Retroviruses, 19:925-928). PCR amplicons were hybridized to the array according to the manufacturer's instructions (see GeneChip® CustomSeq® Resequencing Array Protocol, part number 701231 Rev. 5 available from Affymetrix, Santa Clara, Calif.). Sequences were imported into Operating System and analyzed using Gene Chip Sequence Analysis software to detect polymorphisms based on hybridization intensities (Affymetrix, Santa Clara, Calif.). All samples were also sequenced using ABI technology. FIG. 2 depicts the results of an assay demonstrating the array's ability to detect both sequences in a mixture of a low-abundance (1%) and high abundance (99%) HIV sequences. Among these 20 samples, 3 (15%) had low-abundance resistant variants detected at baseline that were too infrequently represented to be detectable by standard sequencing. In one patient, a viral variant with a K103N mutation in the HIV RT gene that was not detected by standard sequencing was easily detected by the microarray assay utilizing sequences specifically designed to detect the presence of a K103N mutation (see, for example, SEQ ID NOS: 1, 23 and 24). Although this experimental example demonstrates the sensitivity using only one known mutation, one with skill in the art will appreciate that these same detection levels are possible for any mutation of both HIV and HCV.

### Example 4

### Detection of Mutations of HIV Integrase in Patient Samples

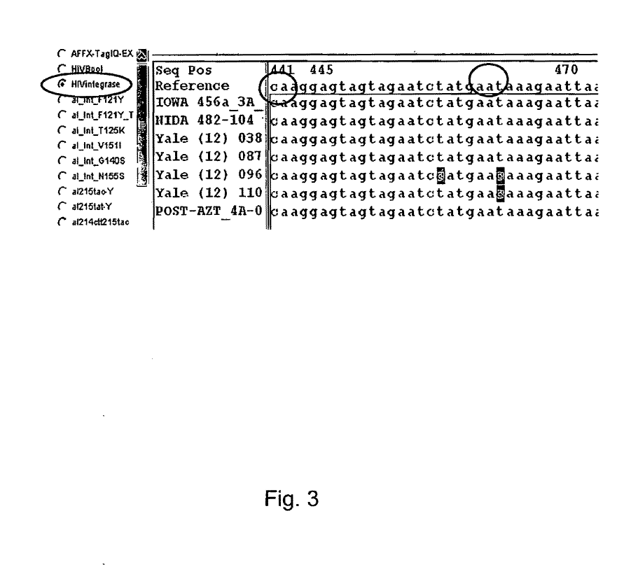

To identify mutations known to be associated with resistance to HIV integrase inhibitors, samples collected from 64 integrase-inhibitor nave patients infected with HIV, and 176 full-length integrase sequences from integrase-inhibitor naïve patients obtained from the HIV Los Alamos database were analyzed with the nucleic acid array described in Example 1. Viral RNA was extracted from patient samples using QIAamp viral RNA extraction kit (QIAGEN Sciences, Germantown, Md.) and used as template in two-round RT-PCR (First Round: SuperScript II RT-TAQ Mix; primer 1—GGAATCATTCAAGCACAACCAGA (SEQ ID NO:120); primer 2—TCTCCTGTATGCAGACCCCAATAT (SEQ ID NO:121); 1 cycle 48.degree.C. for 30 min, 94.degree.C. for 2 min; 35 cycles 94.degree.C. for 30 sec, 50.degree.C. for 30 sec, 72.degree.C. for 60 sec; 1 cycle 72.degree.C. for 10 min; Second Round: Taq DNA Polymerase; primer 1—TCTACCTGGCATGGGTACCA (SEQ ID NO:122); primer 2—CCTAGTGGGATGTGTACTTCTGA (SEQ ID NO:123); 35 cycles 94.degree.C. for 30 sec, 50.degree.C. for 30 sec, 72.degree.C. for 60 sec; 1 cycle 72.degree.C. for 10 min). PCR amplicons were hybridized to the array according to the manufacturer's instructions (see GeneChip® CustomSeq® Resequencing Array Protocol, part number 701231 Rev. 5 available from Affymetrix, Santa Clara, Calif.). Sequences were imported into Gene Chip Operating System and analyzed using Gene Chip Sequence Analysis software to detect polymorphisms based on hybridization intensities (Affymetrix, Santa Clara, Calif.). All samples were also sequenced using ABI technology. FIG. 3 depicts the results of an example assay demonstrating the array's ability to detect HIV integrase mutations in patient samples. Overall call rates for the entire gene ranged from 94% to 99.9% depending on the sample interrogated. Probes on the array to detect mutations known to be associated with integrase inhibitor resistance were designed according to the reference sequences represented by SEQ ID NOS:2-8. Mutant sequences were quantified by the photon intensity counts from each probe cell.

Analysis of the 240 integrase genes revealed that 62% of the amino acid positions were polymorphic. Integrase mutations associated with integrase inhibitor resistance occurred frequently as natural polymorphisms. Of the 24 amino acid substitutions known to be associated with integrase inhibitor resistance, 12 were found to occur as natural polymorphisms: V72I, A128T, E138K, V151I, S153Y, S153A, M154I, N155H, V165I, V201I, T206S, and S230N. V72I, V165I, V201I and T206S occurred at high frequency. A number of amino acid substitutions known to confer high level integrase inhibitor resistance (including T66I, L74M, F121Y, T125K, G140S, N155S, S230R, V249I, and C280Y) were not found to occur as natural polymorphisms. The data demonstrate that the integrase gene displays a high level of diversity, with 62% of the amino acid positions being polymorphic. Although this experimental example demonstrates the detection of mutations in one gene of HIV, one with skill in the art will appreciate that the experimental methods disclosed here will allow one skilled in the art to detect mutations in any sequence of both HIV and HCV.

### Example 5

### Detection of Mutations of HCV NS3 and NS5B in Patient Samples

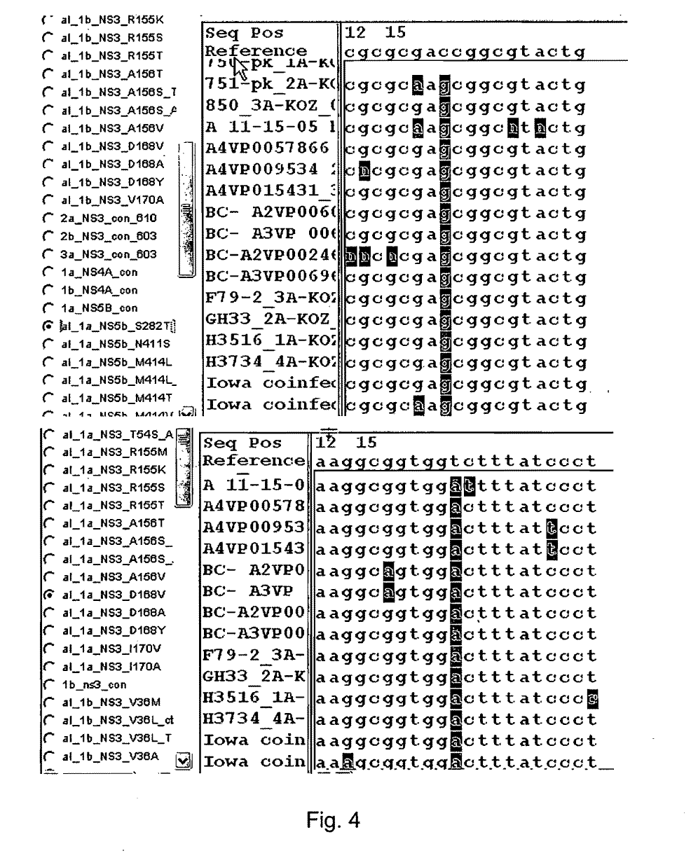

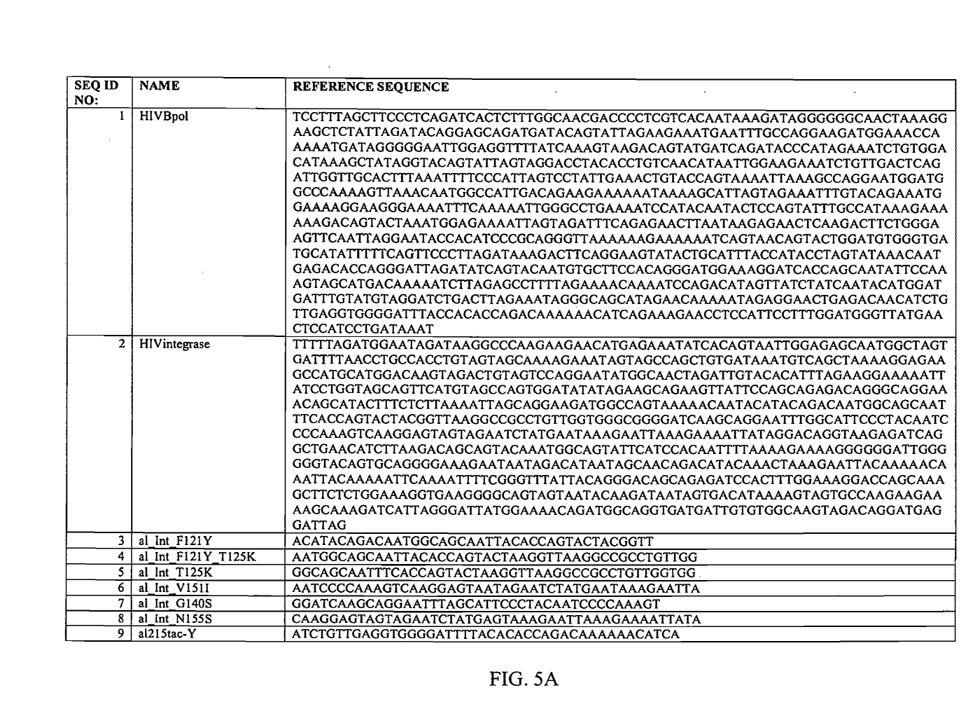

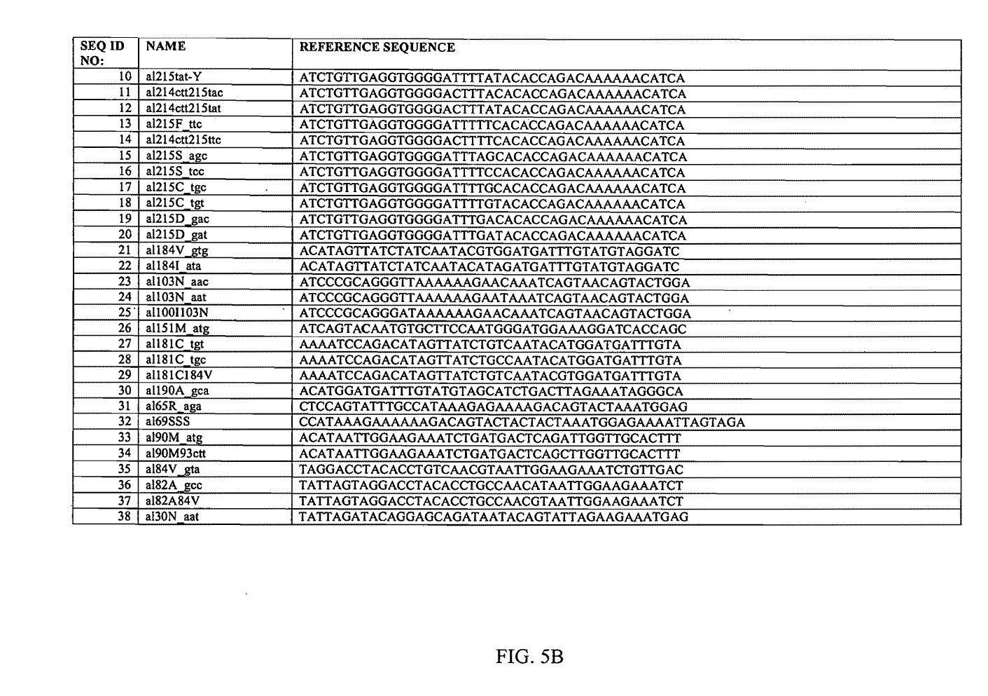

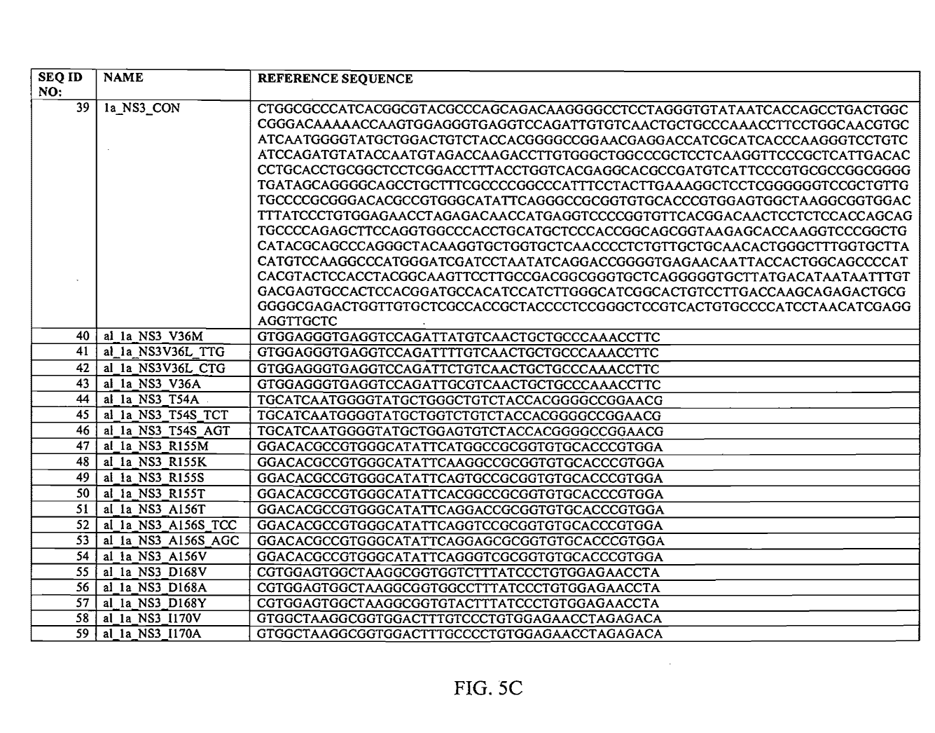

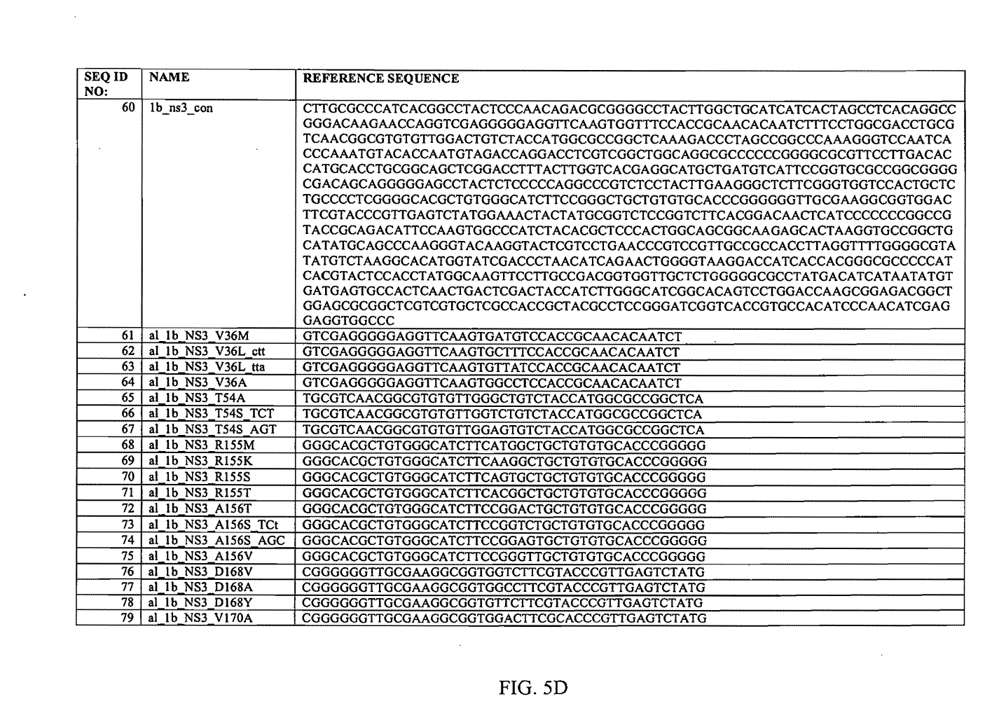

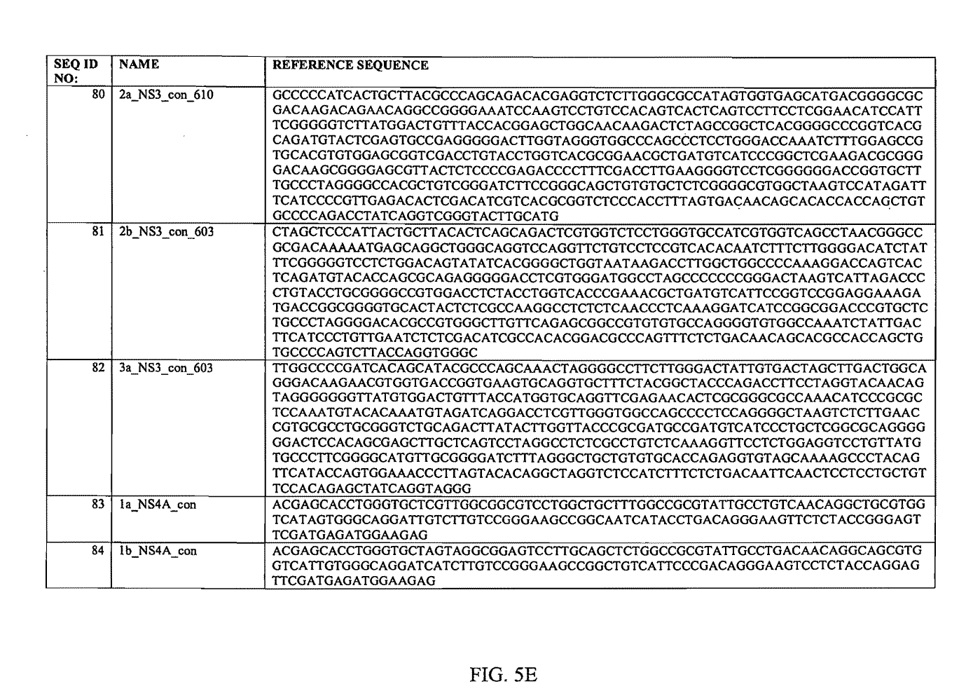

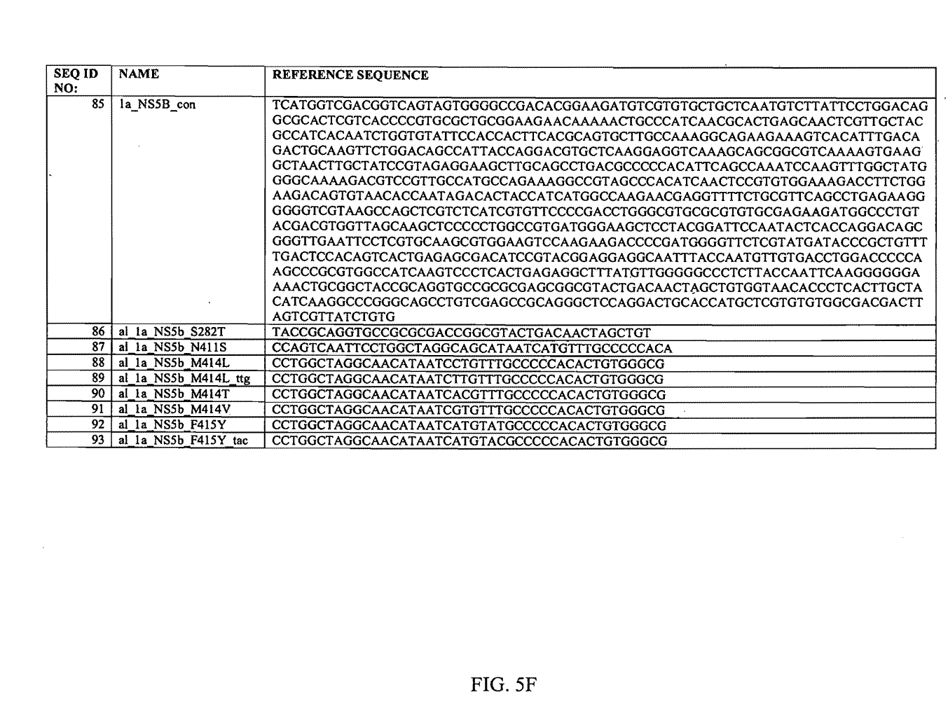

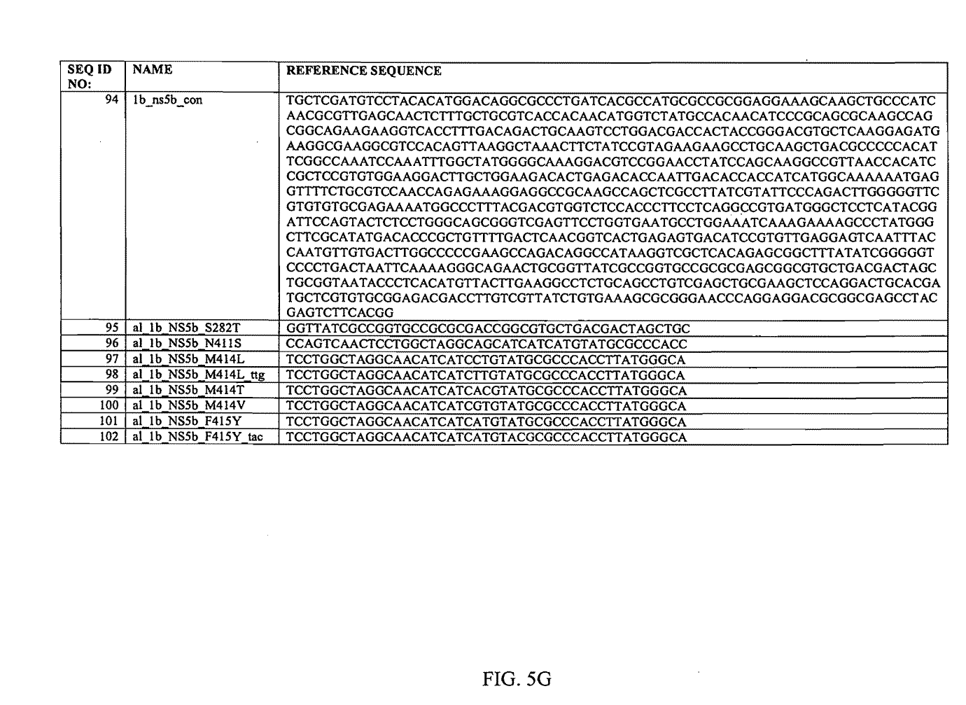

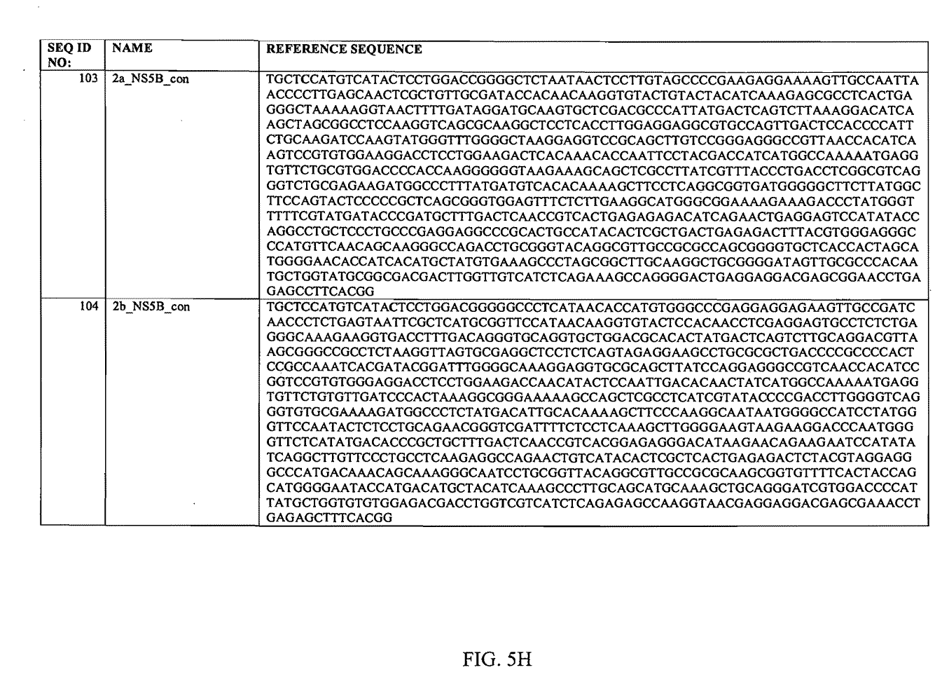

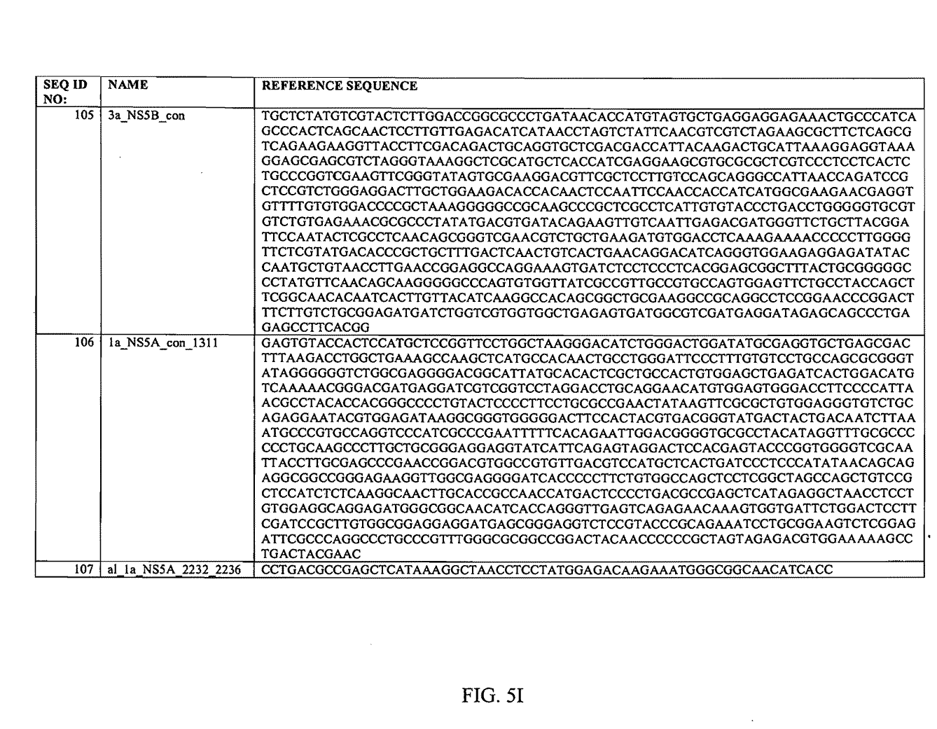

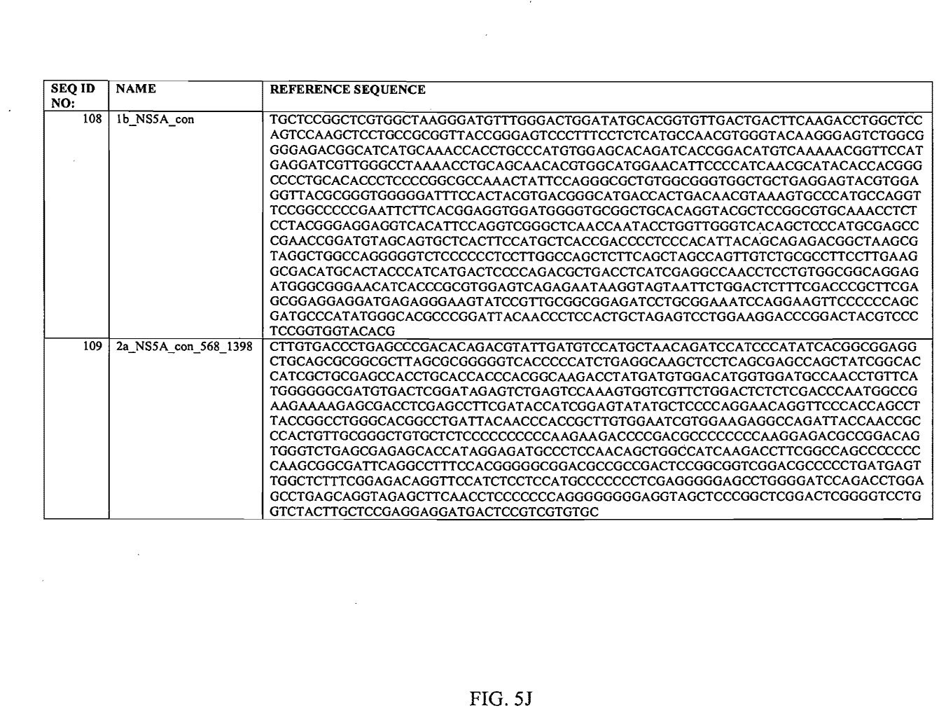

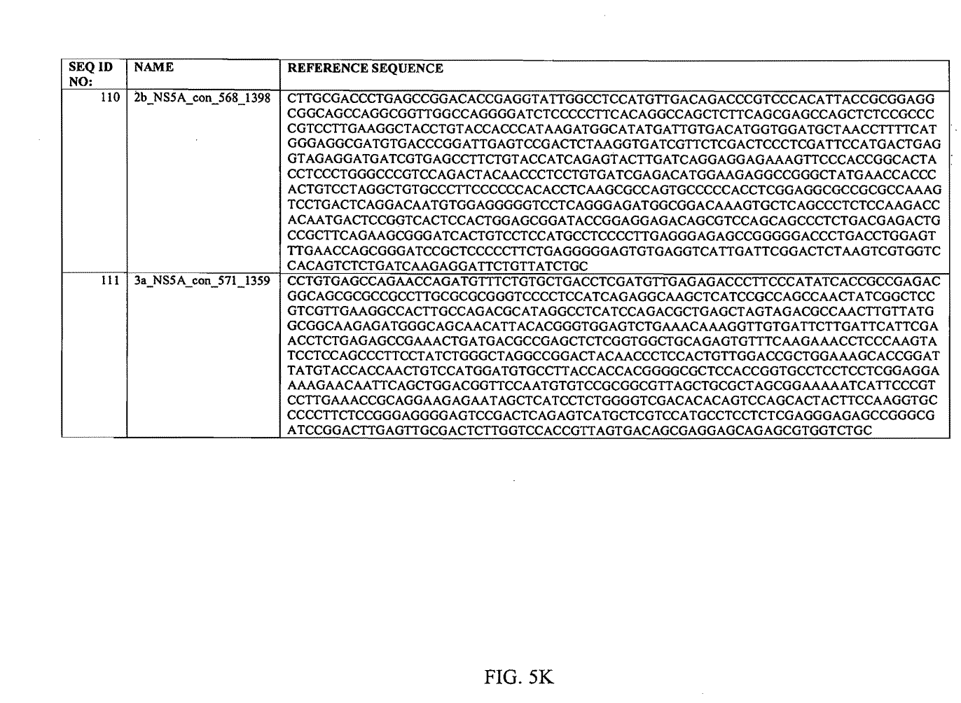

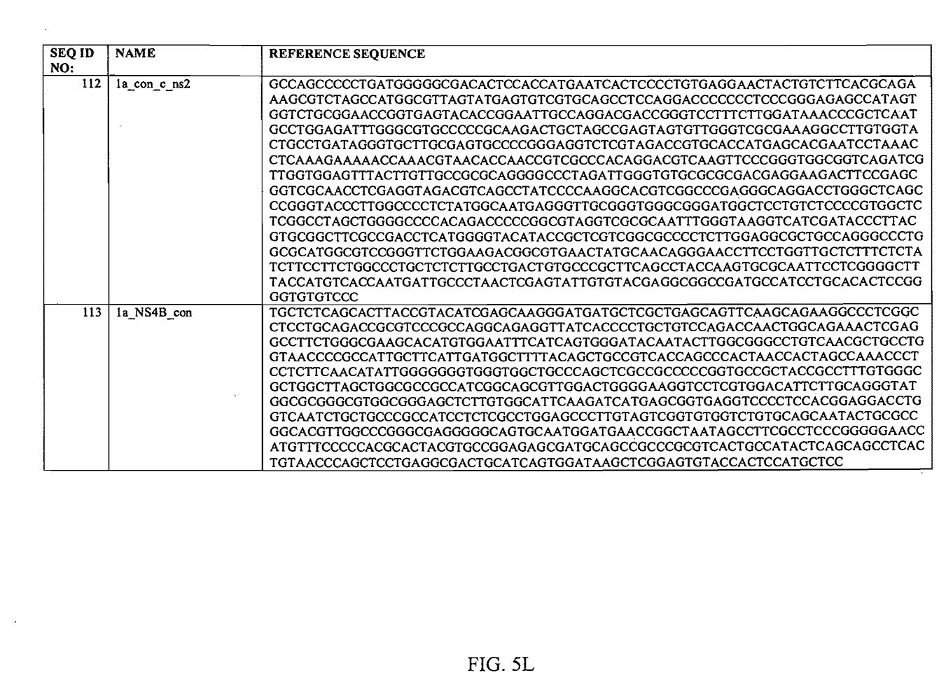

To identify mutations known to be associated with resistance to anti-HCV drugs, samples were collected from 129 antiviral therapy-nave patients known to be infected with HCV. Viral RNA was extracted using QIAamp viral RNA extraction kit (QIAGEN Sciences, Germantown, Md.) and used as template in two-round RT-PCR (First Round NS3: SuperScript II RT-Taq Mix; primer 1—GGGTGAGGTCCAGATYGTGT (SEQ ID NO:124); primer 2—TGGTRAARGTAGGRTCRAGG (SEQ ID NO:125); 1 cycle 50.degree.C. for 30 min; 1 cycle 94.degree.C. for 2 min, 35 cycles 94.degree.C. for 30 sec, 50.degree.C. for 30 sec, 72.degree.C. for 60 sec; 1 cycle 72.degree.C. for 7 min; Second Round NS3: Taq DNA Polymerase; primer 1—ATCAAYGGGGTRTGCTGGAC (SEQ ID NO:126); primer 2—GGGCTGCCHGTRGTAA TTGT (SEQ ID NO:127); 35 cycles 94.degree.C. for 30 sec, 50.degree.C. for 30 sec, 72.degree.C. for 60 sec; 1 cycle 72.degree.C. for 7 min; First Round NS5B: SuperScript II RT-Taq Mix; primer 1—TGGGGATCCCGTATGATACCCGCTGCTTTG (SEQ ID NO:128); primer 2—GGCGGAATTCCTGGTCATAGCCTCCGTGAA (SEQ ID NO:129); 1 cycle 50.degree.C. for 30 min; 1 cycle 94.degree.C. for 2 min, 35 cycles 94.degree.C. for 30 sec, 55.degree.C. for 30 sec, 72.degree.C. for 60 sec; 1 cycle 72.degree.C. for 7 min; Second Round NS5B: Taq DNA Polymerase; primer 1—CTCAACCGTCACTGAGAGAGACAT (SEQ ID NO:130); primer 2—GCTCTCAGGCTCGCCGCGTCCTC (SEQ ID NO:131); 35 cycles 94.degree.C. for 30 sec, 55.degree.C. for 30 sec, 72.degree.C. for 60 sec; 1 cycle 72.degree.C. for 7 min) (See also Nakano, 2004, J Inf Dis 190:1098; Yao et al., 2005, Virol J, 2:88; Winters et al., 2006, J Virol 80:4196-4199). PCR amplicons were hybridized to the array according to the manufacturer's instructions (see GeneChip® CustomSeq® Resequencing Array Protocol, part number 701231 Rev. 5 available from Affymetrix, Santa Clara, Calif.). FIG. 4 depicts the results of an example assay demonstrating the array's ability to detect HCV NS3 and NSSB mutations in patient samples. One-hundred twenty-nine discrete NS3 gene sequences and 109 discrete NS5B gene sequences were analyzed using the nucleic acid array described in Example 1. Sequences were imported into Gene Chip Operating System and analyzed using Gene Chip Sequence Analysis software to detect polymorphisms based on hybridization intensities (Affymetrix, Santa Clara, Calif.).

Of the NS3 gene sequences, 56.8% of the nucleotide, and 42% of the amino acid, positions were found to be polymorphic. Of the NSSB sequences, 69.3% of the nucleotide, and 29.8% of the amino acid positions were found to be polymorphic. Positions in the NS3 gene associated with drug resistance (i.e., codons 36, 54, 155, 156, 168, and 170) and positions in the NS5B gene associated with drug resistance (i.e., codons 282 and 316) were highly conserved with no amino acid changes known to be associated with resistance identified in the sample set. The nucleic acid array was able to determine the sequence at known major HCV protease inhibitor positions in 99.2% (121 of 122 samples).

Although this experimental example demonstrates the detection of mutations in two genes of HCV, one with skill in the art will appreciate that the experimental methods disclosed here will allow one skilled in the art to detect mutations in any sequence of both HIV and HCV.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. An array of nucleic acid probes immobilized on a solid support, the array comprising:
a first probe set comprising a plurality of probes, each probe comprising a segment of at least fifteen nucleotides exactly complementary to a subsequence of a virus reference sequence, the segment including at least one interrogation position complementary to a corresponding nucleotide in the virus reference sequence; and
second, third and fourth probe sets, each probe set comprising a corresponding probe for each probe in the first probe set, the probes in the second, third and fourth probe sets being identical to the corresponding probe from the first probe set or a subsequence of at least fifteen nucleotides thereof that includes the interrogation position, except that the interrogation position is occupied by a different nucleotide in each of the four corresponding probes from the four probe sets;
wherein said virus reference sequence comprises SEQ ID NOS:1, 2, 39, 60, 80-85, 94, 103-106 and 108-113.

2. The array of claim 1, wherein the probes in the first probe set have a single interrogation position, and the array further comprises a fifth probe set comprising a probe for each interrogation position in the first probe set, each probe in the fifth probe set being identical to a sequence comprising a corresponding probe from the first probe set or a subsequence of at least fifteen nucleotides thereof that includes the interrogation position, except that the interrogation position is deleted in the corresponding probe from the fifth probe set.

3. The array of claim 1, wherein the probes in the first probe set have a single interrogation position, and the array further comprises a fifth probe set comprising a probe for each interrogation position in the first probe set, each probe in the fifth probe set being identical to a sequence comprising the corresponding probe from the first probe set or a subsequence of at least fifteen nucleotides thereof that includes the interrogation position, except that an additional nucleotide is inserted adjacent to the single interrogation position in the corresponding probe from the first probe set.

4. The array of claim 1, wherein said virus reference sequence additionally comprises known drug resistance mutations comprising SEQ ID NOS:3-38, 40-59, 61-79, 86-93, 95-102 and 107.

5. A method of identifying a mutation in a viral gene sequence in a sample, said method comprising: hybridizing nucleic acid derived from the sample to the array of claim 1; and analyzing the hybridization pattern to estimate the sequence of the nucleic acid.

6. A method of identifying a mutation in a viral gene sequence in a sample, said method comprising: hybridizing nucleic acid derived from the sample to the array of claim 2; and analyzing the hybridization pattern to estimate the sequence of the nucleic acid.

7. A method of identifying a mutation in a viral gene sequence in a sample, said method comprising: hybridizing nucleic acid derived from the sample to the array of claim 3; and analyzing the hybridization pattern to estimate the sequence of the nucleic acid.

8. A method of identifying a mutation in a viral gene sequence in a sample, said method comprising: hybridizing nucleic acid derived from the sample to the array of claim 4; and analyzing the hybridization pattern to estimate the sequence of the nucleic acid.

9. The method of claim 5, wherein said viral gene sequence is selected from the group consisting of an HIV gene sequence and an HCV gene sequence.

10. The method of claim 6, wherein said viral gene sequence is selected from the group consisting of an HIV gene sequence and an HCV gene sequence.

11. The method of claim 7, wherein said viral gene sequence is selected from the group consisting of an HIV gene sequence and an HCV gene sequence.

12. The method of claim 8, wherein said viral gene sequence is selected from the group consisting of an HIV gene sequence and an HCV gene sequence.

13. A method of evaluating the effectiveness of the antiviral drug therapy of a virus-infected patient comprising:
a. obtaining a sample from a virus-infected patient, and
b. hybridizing nucleic acid derived from the sample to the array of claim 1 and analyzing the hybridization pattern to estimate the sequence of the nucleic acid, and
c. determining whether the sample comprises a nucleic acid having a mutation associated with resistance to an antiviral drug therapy.

14. A method of evaluating the effectiveness of the antiviral drug therapy of a virus-infected patient comprising:
a. obtaining a sample from a virus-infected patient, and
b. hybridizing nucleic acid derived from the sample to the array of claim 2 and analyzing the hybridization pattern to estimate the sequence of the nucleic acid, and
c. determining whether the sample comprises a nucleic acid having a mutation associated with resistance to an antiviral drug therapy.

15. A method of evaluating the effectiveness of the antiviral drug therapy of a virus-infected patient comprising:
a. obtaining a sample from a virus-infected patient, and
b. hybridizing nucleic acid derived from the sample to the array of claim 3 and analyzing the hybridization pattern to estimate the sequence of the nucleic acid, and
c. determining whether the sample comprises a nucleic acid having a mutation associated with resistance to an antiviral drug therapy.

16. A method of evaluating the effectiveness of the antiviral drug therapy of a virus-infected patient comprising:
a. obtaining a sample from a virus-infected patient, and
b. hybridizing nucleic acid derived from the sample to the array of claim 4 and analyzing the hybridization pattern to estimate the sequence of the nucleic acid, and
c. determining whether the sample comprises a nucleic acid having a mutation associated with resistance to an antiviral drug therapy.

17. The method of claim 13, wherein said virus-infected patient is infected with a virus selected from the group consisting of HIV, HCV, and combinations thereof.

18. The method of claim 14, wherein said virus-infected patient is infected with a virus selected from the group consisting of HIV, HCV, and combinations thereof.

19. The method of claim 15, wherein said virus-infected patient is infected with a virus selected from the group consisting of HIV, HCV, and combinations thereof.

20. The method of claim 16, wherein said virus-infected patient is infected with a virus selected from the group consisting of HIV, HCV, and combinations thereof.


SEQUENCE LISTING (131 sequences)

SEQ ID NO: 1 - DNA, 1041 bp, Human immunodeficiency virus
tcctttagcttccctcagatcactctttggcaacgacccctcgtcacaataaagataggggggcaactaaaggaagctctattagatacaggagcagatgatacagtattagaagaaatgaatttgccaggaagatggaaaccaaaaatgatagggggaattggaggttttatcaaagtaagacagtatgatcagatacccatagaaatctgtggacataaagctataggtacagtattagtaggacctacacctgtcaacataattggaagaaatctgttgactcagattggttgcactttaaattttcccattagtcctattgaaactgtaccagtaaaattaaagccaggaatggatggcccaaaagttaaacaatggccattgacagaagaaaaaataaaagcattagtagaaatttgtacagaaatggaaaaggaagggaaaatttcaaaaattgggcctgaaaatccatacaatactccagtatttgccataaagaaaaaagacagtactaaatggagaaaattagtagatttcagagaacttaataagagaactcaagacttctgggaagttcaattaggaataccacatcccgcagggttaaaaaagaaaaaatcagtaacagtactggatgtgggtgatgcatatttttcagttcccttagataaagacttcaggaagtatactgcatttaccatacctagtataaacaatgagacaccagggattagatatcagtacaatgtgcttccacagggatggaaaggatcaccagcaatattccaaagtagcatgacaaaaatcttagagccttttagaaaacaaaatccagacatagttatctatcaatacatggatgatttgtatgtaggatctgacttagaaatagggcagcatagaacaaaaatagaggaactgagacaacatctgttgaggtggggatttaccacaccagacaaaaaacatcagaaagaacctccattcctttggatgggttatgaactccatcctgataaatggacagtacagcctata

SEQ ID NO: 2 - DNA, 867 bp, Human immunodeficiency virus
tttttagatggaatagataaggcccaagaagaacatgagaaatatcacagtaattggagagcaatggctagtgattttaacctgccacctgtagtagcaaaagaaatagtagccagctgtgataaatgtcagctaaaaggagaagccatgcatggacaagtagactgtagtccaggaatatggcaactagattgtacacatttagaaggaaaaattatcctggtagcagttcatgtagccagtggatatatagaagcagaagttattccagcagagacagggcaggaaacagcatactttctcttaaaattagcaggaagatggccagtaaaaacaatacatacagacaatggcagcaatttcaccagtactacggttaaggccgcctgttggtgggcggggatcaagcaggaatttggcattccctacaatccccaaagtcaaggagtagtagaatctatgaataaagaattaaagaaaattataggacaggtaagagatcaggctgaacatcttaagacagcagtacaaatggcagtattcatccacaattttaaaagaaaaggggggattggggggtacagtgcaggggaaagaataatagacataatagcaacagacatacaaactaaagaattacaaaaacaaattacaaaaattcaaaattttcgggtttattacagggacagcagagatccactttggaaaggaccagcaaagcttctctggaaaggtgaaggggcagtagtaatacaagataatagtgacataaaagtagtgccaagaagaaaagcaaagatcattagggattatggaaaacagatggcaggtgatgattgtgtggcaagtagacaggatgaggattag

SEQ ID NO: 3 - DNA, 40 bp, Human immunodeficiency virus
acatacagacaatggcagcaattacaccagtactacggtt

SEQ ID NO: 4 - DNA, 45 bp, Human immunodeficiency virus
aatggcagcaattacaccagtactaaggttaaggccgcctgttgg

SEQ ID NO: 5 - DNA, 45 bp, Human immunodeficiency virus
ggcagcaatttcaccagtactaaggttaaggccgcctgttggtgg

SEQ ID NO: 6 - DNA, 45 bp, Human immunodeficiency virus
aatccccaaagtcaaggagtaatagaatctatgaataaagaatta

SEQ ID NO: 7 - DNA, 41 bp, Human immunodeficiency virus
ggatcaagcaggaatttagcattccctacaatccccaaagt

SEQ ID NO: 8 - DNA, 45 bp, Human immunodeficiency virus
caaggagtagtagaatctatgagtaaagaattaaagaaaattata

SEQ ID NO: 9 - DNA, 43 bp, Human immunodeficiency virus
atctgttgaggtggggattttacacaccagacaaaaaacatca

SEQ ID NO: 10 - DNA, 43 bp, Human immunodeficiency virus
atctgttgaggtggggattttatacaccagacaaaaaacatca

SEQ ID NO: 11 - DNA, 43 bp, Human immunodeficiency virus
atctgttgaggtggggactttacacaccagacaaaaaacatca

SEQ ID NO: 12 - DNA, 43 bp, Human immunodeficiency virus
atctgttgaggtggggactttatacaccagacaaaaaacatca

SEQ ID NO: 13 - DNA, 43 bp, Human immunodeficiency virus
atctgttgaggtggggatttttcacaccagacaaaaaacatca

SEQ ID NO: 14 - DNA, 43 bp, Human immunodeficiency virus
atctgttgaggtggggacttttcacaccagacaaaaaacatca

SEQ ID NO: 15 - DNA, 43 bp, Human immunodeficiency virus
atctgttgaggtggggatttagcacaccagacaaaaaacatca

SEQ ID NO: 16 - DNA, 43 bp, Human immunodeficiency virus
atctgttgaggtggggattttccacaccagacaaaaaacatca

SEQ ID NO: 17 - DNA, 43 bp, Human immunodeficiency virus
atctgttgaggtggggattttgcacaccagacaaaaaacatca

SEQ ID NO: 18 - DNA, 43 bp, Human immunodeficiency virus
atctgttgaggtggggattttgtacaccagacaaaaaacatca

SEQ ID NO: 19 - DNA, 43 bp, Human immunodeficiency virus
atctgttgaggtggggatttgacacaccagacaaaaaacatca

SEQ ID NO: 20 - DNA, 43 bp, Human immunodeficiency virus
atctgttgaggtggggatttgatacaccagacaaaaaacatca

SEQ ID NO: 21 - DNA, 43 bp, Human immunodeficiency virus
acatagttatctatcaatacgtggatgatttgtatgtaggatc

SEQ ID NO: 22 - DNA, 43 bp, Human immunodeficiency virus
acatagttatctatcaatacatagatgatttgtatgtaggatc

SEQ ID NO: 23 - DNA, 43 bp, Human immunodeficiency virus
atcccgcagggttaaaaaagaacaaatcagtaacagtactgga

SEQ ID NO: 24 - DNA, 43 bp, Human immunodeficiency virus
atcccgcagggttaaaaaagaataaatcagtaacagtactgga

SEQ ID NO: 25 - DNA, 43 bp, Human immunodeficiency virus
atcccgcagggataaaaaagaacaaatcagtaacagtactgga

SEQ ID NO: 26 - DNA, 43 bp, Human immunodeficiency virus
atcagtacaatgtgcttccaatgggatggaaaggatcaccagc

SEQ ID NO: 27 - DNA, 43 bp, Human immunodeficiency virus
aaaatccagacatagttatctgtcaatacatggatgatttgta

SEQ ID NO: 28 - DNA, 43 bp, Human immunodeficiency virus
aaaatccagacatagttatctgccaatacatggatgatttgta

SEQ ID NO: 29 - DNA, 43 bp, Human immunodeficiency virus
aaaatccagacatagttatctgtcaatacgtggatgatttgta

SEQ ID NO: 30 - DNA, 43 bp, Human immunodeficiency virus
acatggatgatttgtatgtagcatctgacttagaaatagggca

SEQ ID NO: 31 - DNA, 43 bp, Human immunodeficiency virus
ctccagtatttgccataaagagaaaagacagtactaaatggag

SEQ ID NO: 32 - DNA, 49 bp, Human immunodeficiency virus
ccataaagaaaaaagacagtactactactaaatggagaaaattagtaga

SEQ ID NO: 33 - DNA, 43 bp, Human immunodeficiency virus
acataattggaagaaatctgatgactcagattggttgcacttt

SEQ ID NO: 34 - DNA, 43 bp, Human immunodeficiency virus
acataattggaagaaatctgatgactcagcttggttgcacttt

SEQ ID NO: 35 - DNA, 43 bp, Human immunodeficiency virus
taggacctacacctgtcaacgtaattggaagaaatctgttgac

SEQ ID NO: 36 - DNA, 43 bp, Human immunodeficiency virus
tattagtaggacctacacctgccaacataattggaagaaatct

SEQ ID NO: 37 - DNA, 43 bp, Human immunodeficiency virus
tattagtaggacctacacctgccaacgtaattggaagaaatct

SEQ ID NO: 38 - DNA, 43 bp, Human immunodeficiency virus
tattagatacaggagcagataatacagtattagaagaaatgag

SEQ ID NO: 39 - DNA, 1893 bp, Hepatitis C virus
ctggcgcccatcacggcgtacgcccagcagacaaggggcctcctagggtgtataatcaccagcctgactggccgggacaaaaaccaagtggagggtgaggtccagattgtgtcaactgctgcccaaaccttcctggcaacgtgcatcaatggggtatgctggactgtctaccacggggccggaacgaggaccatcgcatcacccaagggtcctgtcatccagatgtataccaatgtagaccaagaccttgtgggctggcccgctcctcaaggttcccgctcattgacaccctgcacctgcggctcctcggacctttacctggtcacgaggcacgccgatgtcattcccgtgcgccggcggggtgatagcaggggcagcctgctttcgccccggcccatttcctacttgaaaggctcctcggggggtccgctgttgtgccccgcgggacacgccgtgggcatattcagggccgcggtgtgcacccgtggagtggctaaggcggtggactttatccctgtggagaacctagagacaaccatgaggtccccggtgttcacggacaactcctctccaccagcagtgccccagagcttccaggtggcccacctgcatgctcccaccggcagcggtaagagcaccaaggtcccggctgcatacgcagcccagggctacaaggtgctggtgctcaacccctctgttgctgcaacactgggctttggtgcttacatgtccaaggcccatgggatcgatcctaatatcaggaccggggtgagaacaattaccactggcagccccatcacgtactccacctacggcaagttccttgccgacggcgggtgctcagggggtgcttatgacataataatttgtgacgagtgccactccacggatgccacatccatcttgggcatcggcactgtccttgaccaagcagagactgcgggggcgagactggttgtgctcgccaccgctacccctccgggctccgtcactgtgccccatcctaacatcgaggaggttgctctgtccaccaccggagagatccctttttacggcaaggctatccccctcgaggtaatcaagggggggagacatctcatcttctgtcactcaaagaagaagtgcgacgagctcgccgcaaagctggtcgcattgggcatcaatgccgtggcctactaccgcggtcttgacgtgtctgtcatcccgaccagcggcgatgttgtcgtcgtggcaaccgatgctctcatgaccggctttaccggcgacttcgactcggtgatagactgcaacacgtgtgtcacccagacagtcgatttcagccttgaccctaccttcaccattgagacaaccacgctcccccaggatgctgtctcccgcactcaacgtcggggcaggactggcagggggaagccaggcatctacagatttgtggcaccgggggagcgcccctccggcatgttcgactcgtccgtcctctgtgagtgctatgacgcgggctgtgcttggtatgagctcacgcccgccgagactacagttaggctacgagcgtacatgaacaccccggggcttcccgtgtgccaggaccatcttgaattttgggagggcgtctttacgggcctcactcatatagatgcccactttctatcccagacaaagcagagtggggagaactttccttacctggtagcgtaccaagccaccgtgtgcgctagggctcaagcccctcccccatcgtgggaccagatgtggaagtgtttgatccgcctcaaacccaccctccatgggccaacacccctgctatacagactgggcgctgttcagaatgaagtcaccctgacgcacccagtcaccaaatacatcatgacatgcatgtcggccgacctggaggtcgtc

SEQ ID NO: 40 - DNA, 45 bp, Hepatitis C virus
gtggagggtgaggtccagattatgtcaactgctgcccaaaccttc

SEQ ID NO: 41 - DNA, 45 bp, Hepatitis C virus
gtggagggtgaggtccagattttgtcaactgctgcccaaaccttc

SEQ ID NO: 42 - DNA, 45 bp, Hepatitis C virus
gtggagggtgaggtccagattctgtcaactgctgcccaaaccttc

SEQ ID NO: 43 - DNA, 45 bp, Hepatitis C virus
gtggagggtgaggtccagattgcgtcaactgctgcccaaaccttc

SEQ ID NO: 44 - DNA, 45 bp, Hepatitis C virus
tgcatcaatggggtatgctgggctgtctaccacggggccggaacg

SEQ ID NO: 45 - DNA, 45 bp, Hepatitis C virus
tgcatcaatggggtatgctggtctgtctaccacggggccggaacg

SEQ ID NO: 46 - DNA, 45 bp, Hepatitis C virus
tgcatcaatggggtatgctggagtgtctaccacggggccggaacg

SEQ ID NO: 47 - DNA, 45 bp, Hepatitis C virus
ggacacgccgtgggcatattcatggccgcggtgtgcacccgtgga

SEQ ID NO: 48 - DNA, 45 bp, Hepatitis C virus
ggacacgccgtgggcatattcaaggccgcggtgtgcacccgtgga

SEQ ID NO: 49 - DNA, 45 bp, Hepatitis C virus
ggacacgccgtgggcatattcagtgccgcggtgtgcacccgtgga

SEQ ID NO: 50 - DNA, 45 bp, Hepatitis C virus
ggacacgccgtgggcatattcacggccgcggtgtgcacccgtgga

SEQ ID NO: 51 - DNA, 45 bp, Hepatitis C virus
ggacacgccgtgggcatattcaggaccgcggtgtgcacccgtgga

SEQ ID NO: 52 - DNA, 45 bp, Hepatitis C virus
ggacacgccgtgggcatattcaggtccgcggtgtgcacccgtgga

SEQ ID NO: 53 - DNA, 45 bp, Hepatitis C virus
ggacacgccgtgggcatattcaggagcgcggtgtgcacccgtgga

SEQ ID NO: 54 - DNA, 45 bp, Hepatitis C virus
ggacacgccgtgggcatattcagggtcgcggtgtgcacccgtgga

SEQ ID NO: 55 - DNA, 45 bp, Hepatitis C virus
cgtggagtggctaaggcggtggtctttatccctgtggagaaccta

SEQ ID NO: 56 - DNA, 45 bp, Hepatitis C virus
cgtggagtggctaaggcggtggcctttatccctgtggagaaccta

SEQ ID NO: 57 - DNA, 45 bp, Hepatitis C virus
cgtggagtggctaaggcggtgtactttatccctgtggagaaccta

SEQ ID NO: 58 - DNA, 45 bp, Hepatitis C virus
gtggctaaggcggtggactttgtccctgtggagaacctagagaca

SEQ ID NO: 59 - DNA, 45 bp, Hepatitis C virus
gtggctaaggcggtggactttgcccctgtggagaacctagagaca

SEQ ID NO: 60 - DNA, 1893 bp, Hepatitis C virus
cttgcgcccatcacggcctactcccaacagacgcggggcctacttggctgcatcatcactagcctcacaggccgggacaagaaccaggtcgagggggaggttcaagtggtttccaccgcaacacaatctttcctggcgacctgcgtcaacggcgtgtgttggactgtctaccatggcgccggctcaaagaccctagccggcccaaagggtccaatcacccaaatgtacaccaatgtagaccaggacctcgtcggctggcaggcgccccccggggcgcgttccttgacaccatgcacctgcggcagctcggacctttacttggtcacgaggcatgctgatgtcattccggtgcgccggcggggcgacagcagggggagcctactctcccccaggcccgtctcctacttgaagggctcttcgggtggtccactgctctgcccctcggggcacgctgtgggcatcttccgggctgctgtgtgcacccggggggttgcgaaggcggtggacttcgtacccgttgagtctatggaaactactatgcggtctccggtcttcacggacaactcatcccccccggccgtaccgcagacattccaagtggcccatctacacgctcccactggcagcggcaagagcactaaggtgccggctgcatatgcagcccaagggtacaaggtactcgtcctgaacccgtccgttgccgccaccttaggttttggggcgtatatgtctaaggcacatggtatcgaccctaacatcagaactggggtaaggaccatcaccacgggcgcccccatcacgtactccacctatggcaagttccttgccgacggtggttgctctgggggcgcctatgacatcataatatgtgatgagtgccactcaactgactcgactaccatcttgggcatcggcacagtcctggaccaagcggagacggctggagcgcggctcgtcgtgctcgccaccgctacgcctccgggatcggtcaccgtgccacatcccaacatcgaggaggtggccctgtccaacactggagagatccccttctatggcaaagccatccccatcgaggccatcaagggggggaggcatctcattttctgccattccaagaagaaatgtgacgagctcgccgcaaagctgtcgggcctcggactcaatgctgtagcgtattaccggggtcttgatgtgtccgtcataccgaccagcggagacgtcgttgtcgtggcaacagacgctctaatgacgggctttaccggcgactttgactcagtgatcgactgtaacacatgtgtcacccagacagtcgacttcagcttggaccccaccttcaccattgagacgacgaccgtgccccaagacgcggtgtcgcgctcgcagcggcgaggcaggactggtaggggcaggagaggcatctacaggtttgtgactccaggagaacggccctcgggcatgttcgattcctcggtcctgtgtgagtgctatgacgcgggctgtgcttggtacgagctcacgcccgccgagacctcggttaggttgcgggcttacctaaatacaccagggttgcccgtctgccaggaccatctggagttctgggagagcgtcttcacaggcctcacccacatagatgcccacttcctgtcccagactaagcaggcaggagacaacttcccctacctggtagcataccaagctacagtgtgcgccagggctcaggctccacctccatcgtgggaccaaatgtggaagtgtctcatacggctaaagcctacgctgcacgggccaacacccctgctgtataggctaggagccgtccaaaatgaggtcaccctcacacaccccataaccaaatacatcatggcatgcatgtcggctgacctggaggtcgtc

SEQ ID NO: 61 - DNA, 42 bp, Hepatitis C virus
gtcgagggggaggttcaagtgatgtccaccgcaacacaatct

SEQ ID NO: 62 - DNA, 42 bp, Hepatitis C virus
gtcgagggggaggttcaagtgctttccaccgcaacacaatct

SEQ ID NO: 63 - DNA, 42 bp, Hepatitis C virus
gtcgagggggaggttcaagtgttatccaccgcaacacaatct

SEQ ID NO: 64 - DNA, 42 bp, Hepatitis C virus
gtcgagggggaggttcaagtggcctccaccgcaacacaatct

SEQ ID NO: 65 - DNA, 45 bp, Hepatitis C virus
tgcgtcaacggcgtgtgttgggctgtctaccatggcgccggctca

SEQ ID NO: 66 - DNA, 45 bp, Hepatitis C virus
tgcgtcaacggcgtgtgttggtctgtctaccatggcgccggctca

SEQ ID NO: 67 - DNA, 45 bp, Hepatitis C virus
tgcgtcaacggcgtgtgttggagtgtctaccatggcgccggctca

SEQ ID NO: 68 - DNA, 45 bp, Hepatitis C virus
gggcacgctgtgggcatcttcatggctgctgtgtgcacccggggg

SEQ ID NO: 69 - DNA, 45 bp, Hepatitis C virus
gggcacgctgtgggcatcttcaaggctgctgtgtgcacccggggg

SEQ ID NO: 70 - DNA, 45 bp, Hepatitis C virus
gggcacgctgtgggcatcttcagtgctgctgtgtgcacccggggg

SEQ ID NO: 71 - DNA, 45 bp, Hepatitis C virus
gggcacgctgtgggcatcttcacggctgctgtgtgcacccggggg

SEQ ID NO: 72 - DNA, 45 bp, Hepatitis C virus
gggcacgctgtgggcatcttccggactgctgtgtgcacccggggg

SEQ ID NO: 73 - DNA, 45 bp, Hepatitis C virus
gggcacgctgtgggcatcttccggtctgctgtgtgcacccggggg

SEQ ID NO: 74 - DNA, 45 bp, Hepatitis C virus
gggcacgctgtgggcatcttccggagtgctgtgtgcacccggggg

SEQ ID NO: 75 - DNA, 45 bp, Hepatitis C virus
gggcacgctgtgggcatcttccgggttgctgtgtgcacccggggg

SEQ ID NO: 76 - DNA, 45 bp, Hepatitis C virus
cggggggttgcgaaggcggtggtcttcgtacccgttgagtctatg

SEQ ID NO: 77 - DNA, 45 bp, Hepatitis C virus
cggggggttgcgaaggcggtggccttcgtacccgttgagtctatg

SEQ ID NO: 78 - DNA, 45 bp, Hepatitis C virus
cggggggttgcgaaggcggtgttcttcgtacccgttgagtctatg

SEQ ID NO: 79 - DNA, 45 bp, Hepatitis C virus
cggggggttgcgaaggcggtggacttcgcacccgttgagtctatg

SEQ ID NO: 80 - DNA, 610 bp, Hepatitis C virus
gcccccatcactgcttacgcccagcagacacgaggtctcttgggcgccatagtggtgagcatgacggggcgcgacaagacagaacaggccggggaaatccaagtcctgtccacagtcactcagtccttcctcggaacatccatttcgggggtcttatggactgtttaccacggagctggcaacaagactctagccggctcacggggcccggtcacgcagatgtactcgagtgccgagggggacttggtagggtggcccagccctcctgggaccaaatctttggagccgtgcacgtgtggagcggtcgacctgtacctggtcacgcggaacgctgatgtcatcccggctcgaagacgcggggacaagcggggagcgttactctccccgagacccctttcgaccttgaaggggtcctcggggggaccggtgctttgccctaggggccacgctgtcgggatcttccgggcagctgtgtgctctcggggcgtggctaagtccatagatttcatccccgttgagacactcgacatcgtcacgcggtctcccacctttagtgacaacagcacaccaccagctgtgccccagacctatcaggtcgggtacttgcatg

SEQ ID NO: 81 - DNA, 603 bp, Hepatitis C virus
ctagctcccattactgcttacactcagcagactcgtggtctcctgggtgccatcgtggtcagcctaacgggccgcgacaaaaatgagcaggctgggcaggtccaggttctgtcctccgtcacacaatctttcttggggacatctatttcgggggtcctctggacagtatatcacggggctggtaataagaccttggctggccccaaaggaccagtcactcagatgtacaccagcgcagagggggacctcgtgggatggcctagcccccccgggactaagtcattagacccctgtacctgcggggccgtggacctctacctggtcacccgaaacgctgatgtcattccggtccggaggaaagatgaccggcggggtgcactactctcgccaaggcctctctcaaccctcaaaggatcatccggcggacccgtgctctgccctaggggacacgccgtgggcttgttcagagcggccgtgtgtgccaggggtgtggccaaatctattgacttcatccctgttgaatctctcgacatcgccacacggacgcccagtttctctgacaacagcacgccaccagctgtgccccagtcttaccaggtgggc

SEQ ID NO: 82 - DNA, 603 bp, Hepatitis C virus
ttggccccgatcacagcatacgcccagcaaactaggggccttcttgggactattgtgactagcttgactggcagggacaagaacgtggtgaccggtgaagtgcaggtgctttctacggctacccagaccttcctaggtacaacagtagggggggttatgtggactgtttaccatggtgcaggttcgagaacactcgcgggcgccaaacatcccgcgctccaaatgtacacaaatgtagatcaggacctcgttgggtggccagcccctccaggggctaagtctcttgaaccgtgcgcctgcgggtctgcagacttatacttggttacccgcgatgccgatgtcatccctgctcggcgcaggggggactccacagcgagcttgctcagtcctaggcctctcgcctgtctcaaaggttcctctggaggtcctgttatgtgcccttcggggcatgttgcggggatctttagggctgctgtgtgcaccagaggtgtagcaaaagccctacagttcataccagtggaaacccttagtacacaggctaggtctccatctttctctgacaattcaactcctcctgctgttccacagagctatcaggtaggg

SEQ ID NO: 83 - DNA, 162 bp, Hepatitis C virus
acgagcacctgggtgctcgttggcggcgtcctggctgctttggccgcgtattgcctgtcaacaggctgcgtggtcatagtgggcaggattgtcttgtccgggaagccggcaatcatacctgacagggaagttctctaccgggagttcgatgagatggaagag

SEQ ID NO: 84 - DNA, 162 bp, Hepatitis C virus
acgagcacctgggtgctagtaggcggagtccttgcagctctggccgcgtattgcctgacaacaggcagcgtggtcattgtgggcaggatcatcttgtccgggaagccggctgtcattcccgacagggaagtcctctaccaggagttcgatgagatggaagag

SEQ ID NO: 85 - DNA, 1734 bp, Hepatitis C virus
tcatggtcgacggtcagtagtggggccgacacggaagatgtcgtgtgctgctcaatgtcttattcctggacaggcgcactcgtcaccccgtgcgctgcggaagaacaaaaactgcccatcaacgcactgagcaactcgttgctacgccatcacaatctggtgtattccaccacttcacgcagtgcttgccaaaggcagaagaaagtcacatttgacagactgcaagttctggacagccattaccaggacgtgctcaaggaggtcaaagcagcggcgtcaaaagtgaaggctaacttgctatccgtagaggaagcttgcagcctgacgcccccacattcagccaaatccaagtttggctatggggcaaaagacgtccgttgccatgccagaaaggccgtagcccacatcaactccgtgtggaaagaccttctggaagacagtgtaacaccaatagacactaccatcatggccaagaacgaggttttctgcgttcagcctgagaaggggggtcgtaagccagctcgtctcatcgtgttccccgacctgggcgtgcgcgtgtgcgagaagatggccctgtacgacgtggttagcaagctccccctggccgtgatgggaagctcctacggattccaatactcaccaggacagcgggttgaattcctcgtgcaagcgtggaagtccaagaagaccccgatggggttctcgtatgatacccgctgttttgactccacagtcactgagagcgacatccgtacggaggaggcaatttaccaatgttgtgacctggacccccaagcccgcgtggccatcaagtccctcactgagaggctttatgttgggggccctcttaccaattcaaggggggaaaactgcggctaccgcaggtgccgcgcgagcggcgtactgacaactagctgtggtaacaccctcacttgctacatcaaggcccgggcagcctgtcgagccgcagggctccaggactgcaccatgctcgtgtgtggcgacgacttagtcgttatctgtgaaagtgcgggggtccaggaggacgcggcgagcctgagagccttcacggaggctatgaccaggtactccgccccccccggggaccccccacaaccagaatacgacttggagcttataacatcatgctcctccaacgtgtcagtcgcccacgacggcgctggaaagagggtctactaccttacccgtgaccctacaacccccctcgcgagagccgcgtgggagacagcaagacacactccagtcaattcctggctaggcaacataatcatgtttgcccccacactgtgggcgaggatgatactgatgacccatttctttagcgtcctcatagccagggatcagcttgaacaggctcttaactgcgagatctacggagcctgctactccatagaaccactggatctacctccaatcattcaaagactccatggcctcagcgcattttcactccacagttactctccaggtgaaatcaatagggtggccgcatgcctcagaaaacttggggtcccgcccttgcgagcttggagacaccgggcccggagcgtccgcgctaggcttctgtccagaggaggcagggctgccatatgtggcaagtacctcttcaactgggcagtaagaacaaagctcaaactcactccaatagcggccgctggccggctggacttgtccggctggttcacggctggctacagcgggggagacatttat

SEQ ID NO: 86 - DNA, 42 bp, Hepatitis C virus
taccgcaggtgccgcgcgaccggcgtactgacaactagctgt

SEQ ID NO: 87 - DNA, 45 bp, Hepatitis C virus
ccagtcaattcctggctaggcagcataatcatgtttgcccccaca

SEQ ID NO: 88 - DNA, 44 bp, Hepatitis C virus
cctggctaggcaacataatcctgtttgcccccacactgtgggcg

SEQ ID NO: 89 - DNA, 44 bp, Hepatitis C virus
cctggctaggcaacataatcttgtttgcccccacactgtgggcg

SEQ ID NO: 90 - DNA, 44 bp, Hepatitis C virus
cctggctaggcaacataatcacgtttgcccccacactgtgggcg

SEQ ID NO: 91 - DNA, 44 bp, Hepatitis C virus
cctggctaggcaacataatcgtgtttgcccccacactgtgggcg

SEQ ID NO: 92 - DNA, 44 bp, Hepatitis C virus
cctggctaggcaacataatcatgtatgcccccacactgtgggcg

SEQ ID NO: 93 - DNA, 44 bp, Hepatitis C virus
cctggctaggcaacataatcatgtacgcccccacactgtgggcg

SEQ ID NO: 94 - DNA, 1776 bp, Hepatitis C virus
tgctcgatgtcctacacatggacaggcgccctgatcacgccatgcgccgcggaggaaagcaagctgcccatcaacgcgttgagcaactctttgctgcgtcaccacaacatggtctatgccacaacatcccgcagcgcaagccagcggcagaagaaggtcacctttgacagactgcaagtcctggacgaccactaccgggacgtgctcaaggagatgaaggcgaaggcgtccacagttaaggctaaacttctatccgtagaagaagcctgcaagctgacgcccccacattcggccaaatccaaatttggctatggggcaaaggacgtccggaacctatccagcaaggccgttaaccacatccgctccgtgtggaaggacttgctggaagacactgagacaccaattgacaccaccatcatggcaaaaaatgaggttttctgcgtccaaccagagaaaggaggccgcaagccagctcgccttatcgtattcccagacttgggggttcgtgtgtgcgagaaaatggccctttacgacgtggtctccacccttcctcaggccgtgatgggctcctcatacggattccagtactctcctgggcagcgggtcgagttcctggtgaatgcctggaaatcaaagaaaagccctatgggcttcgcatatgacacccgctgttttgactcaacggtcactgagagtgacatccgtgttgaggagtcaatttaccaatgttgtgacttggcccccgaagccagacaggccataaggtcgctcacagagcggctttatatcgggggtcccctgactaattcaaaagggcagaactgcggttatcgccggtgccgcgcgagcggcgtgctgacgactagctgcggtaataccctcacatgttacttgaaggcctctgcagcctgtcgagctgcgaagctccaggactgcacgatgctcgtgtgcggagacgaccttgtcgttatctgtgaaagcgcgggaacccaggaggacgcggcgagcctacgagtcttcacggaggctatgactaggtactctgccccccccggggacccgccccaaccagaatacgacttggagttgataacatcatgctcctccaatgtgtcggtcgcgcacgatgcatctggcaaaagggtgtactacctcacccgtgaccccaccaccccccttgcacgggctgcgtgggagacagctagacacactccagtcaactcctggctaggcaacatcatcatgtatgcgcccaccttatgggcaaggatgattctgatgactcacttcttctccatccttctagctcaggagcaacttgaaaaagccctagattgtcagatctacggggcctgttactccattgagccacttgacctacctcagatcattcagcgactccatggtcttagcgcattttcactccatagttactctccaggtgagatcaatagggtggcttcatgcctcaggaaacttggggtaccacccttgcgagtctggagacatcgggccagaagtgtccgcgctaagctactgtcccagggggggagggccgccacttgtggcaaatacctcttcaactgggcagtaaggaccaagcttaaactcactccaatcccggctgcgtcccagttggacttgtccggctggttcgttgctggttacagcgggggagacatatatcacagcctgtctcgtgcccgaccccgctggttcatgttgtgcctactcctactttctgtaggggtaggcatctacctgctccccaaccga

SEQ ID NO: 95 - DNA, 45 bp, Hepatitis C virus
ggttatcgccggtgccgcgcgaccggcgtgctgacgactagctgc

SEQ ID NO: 96 - DNA, 45 bp, Hepatitis C virus
ccagtcaactcctggctaggcagcatcatcatgtatgcgcccacc

SEQ ID NO: 97 - DNA, 45 bp, Hepatitis C virus
tcctggctaggcaacatcatcctgtatgcgcccaccttatgggca

SEQ ID NO: 98 - DNA, 45 bp, Hepatitis C virus
tcctggctaggcaacatcatcttgtatgcgcccaccttatgggca

SEQ ID NO: 99 - DNA, 45 bp, Hepatitis C virus
tcctggctaggcaacatcatcacgtatgcgcccaccttatgggca

SEQ ID NO: 100 - DNA, 45 bp, Hepatitis C virus
tcctggctaggcaacatcatcgtgtatgcgcccaccttatgggca

SEQ ID NO: 101 - DNA, 45 bp, Hepatitis C virus
tcctggctaggcaacatcatcatgtatgcgcccaccttatgggca

SEQ ID NO: 102 - DNA, 45 bp, Hepatitis C virus
tcctggctaggcaacatcatcatgtacgcgcccaccttatgggca

SEQ ID NO: 103 - DNA, 1776 bp, Hepatitis C virus
tgctccatgtcatactcctggaccggggctctaataactccttgtagccccgaagaggaaaagttgccaattaaccccttgagcaactcgctgttgcgataccacaacaaggtgtactgtactacatcaaagagcgcctcactgagggctaaaaaggtaacttttgataggatgcaagtgctcgacgcccattatgactcagtcttaaaggacatcaagctagcggcctccaaggtcagcgcaaggctcctcaccttggaggaggcgtgccagttgactccaccccattctgcaagatccaagtatgggtttggggctaaggaggtccgcagcttgtccgggagggccgttaaccacatcaagtccgtgtggaaggacctcctggaagactcacaaacaccaattcctacgaccatcatggccaaaaatgaggtgttctgcgtggaccccaccaaggggggtaagaaagcagctcgccttatcgtttaccctgacctcggcgtcagggtctgcgagaagatggccctttatgatgtcacacaaaagcttcctcaggcggtgatgggggcttcttatggcttccagtactcccccgctcagcgggtggagtttctcttgaaggcatgggcggaaaagaaagaccctatgggtttttcgtatgatacccgatgctttgactcaaccgtcactgagagagacatcagaactgaggagtccatataccaggcctgctccctgcccgaggaggcccgcactgccatacactcgctgactgagagactttacgtgggagggcccatgttcaacagcaagggccagacctgcgggtacaggcgttgccgcgccagcggggtgctcaccactagcatggggaacaccatcacatgctatgtgaaagccctagcggcttgcaaggctgcggggatagttgcgcccacaatgctggtatgcggcgacgacttggttgtcatctcagaaagccaggggactgaggaggacgagcggaacctgagagccttcacggaggctatgaccaggtattctgcccctcctggtgacccccccagaccggaatatgacctggagctgataacatcttgttcctcaaatgtgtctgtggcgctgggcccacagggccgccgcagatactacctgaccagagaccctaccactccaatcgcccgggctgcctgggaaacagttagacactcccctgtcaattcatggctgggaaacatcatccagtacgccccaaccatatgggttcgcatggtcctgatgacacacttcttctccattctcatggcccaagacaccctggaccagaacctcaactttgagatgtacggatcggtgtactccgtgagtcctttggacctcccagccataattgaaaggttacacgggcttgacgccttctctctgcacacatacactccccacgaactgacgcgggtggcttcagccctcagaaaacttggggcgccacccctcagagcgtggaagagtcgggcgcgtgcagttagggcgtccctcatctcccgtggagggagagcggccgtttgcggtcggtatctcttcaactgggcggtgaagaccaagctcaaactcactccattgccggaggcacgcctcctggatttatccagttggttcaccgtcggcgccggcgggggcgacatttatcacagcgtgtcgcgtgcccgaccccgcttattactccttagcctactcctactttccgtaggggtaggcctcttcctactccccgctcgg

SEQ ID NO: 104 - DNA, 1776 bp, Hepatitis C virus
tgctccatgtcatactcctggacgggggccctcataacaccatgtgggcccgaggaggagaagttgccgatcaaccctctgagtaattcgctcatgcggttccataacaaggtgtactccacaacctcgaggagtgcctctctgagggcaaagaaggtgacctttgacagggtgcaggtgctggacgcacactatgactcagtcttgcaggacgttaagcgggccgcctctaaggttagtgcgaggctcctctcagtagaggaagcctgcgcgctgaccccgccccactccgccaaatcacgatacggatttggggcaaaggaggtgcgcagcttatccaggagggccgtcaaccacatccggtccgtgtgggaggacctcctggaagaccaacatactccaattgacacaactatcatggccaaaaatgaggtgttctgtgttgatcccactaaaggcgggaaaaagccagctcgcctcatcgtataccccgaccttggggtcagggtgtgcgaaaagatggccctctatgacattgcacaaaagcttcccaaggcaataatggggccatcctatgggttccaatactctcctgcagaacgggtcgattttctcctcaaagcttggggaagtaagaaggacccaatggggttctcatatgacacccgctgctttgactcaaccgtcacggagagggacataagaacagaagaatccatatatcaggcttgttccctgcctcaagaggccagaactgtcatacactcgctcactgagagactctacgtaggagggcccatgacaaacagcaaagggcaatcctgcggttacaggcgttgccgcgcaagcggtgttttcactaccagcatggggaataccatgacatgctacatcaaagcccttgcagcatgcaaagctgcagggatcgtggaccccattatgctggtgtgtggagacgacctggtcgtcatctcagagagccaaggtaacgaggaggacgagcgaaacctgagagctttcacggaggctatgaccaggtattccgcccctcccggtgaccttcccagaccggaatatgacttggagcttataacatcctgctcctcaaacgtatcggtagcgctggactctcggggtcgccgccggtacttcctaaccagagaccctaccactccaatcacccgagctgcttgggaaacagtaagacactcccctgtcaattcttggctgggcaacatcatccaatacgcccctacaatctgggtccggatggtcataatgacccacttcttctccatactattggcccaggacactctgaaccaaaatctcaattttgagatgtacggggcagtatattcggtcaatccattagacctaccggccataattgaaaggctacatgggcttgatgccttttcactgcacacatactctccccacgaactctcacgggtggcagcgactctcagaaaacttggagcgcctccccttagagcgtggaagagtcgggcgcgtgctgtgagggcctcactcatcgcccagggagggagggcggccatttgtggccgctacctcttcaactgggcggtgaagacaaagctcaaactcactccattgcccgaggcgagccgcctggatttatccgggtggttcaccgtgggcgccggcgggggcgacatctttcacagcgtgtcgcatgcccgaccccgcctattactcctttgcctactcctacttagcgtaggagtaggcatctttttactccccgctcgg

SEQ ID NO: 105 - DNA, 1776 bp, Hepatitis C virus
tgctctatgtcgtactcttggaccggcgccctgataacaccatgtagtgctgaggaggagaaactgcccatcagcccactcagcaactccttgttgagacatcataacctagtctattcaacgtcgtctagaagcgcttctcagcgtcagaagaaggttaccttcgacagactgcaggtgctcgacgaccattacaagactgcattaaaggaggtaaaggagcgagcgtctagggtaaaggctcgcatgctcaccatcgaggaagcgtgcgcgctcgtccctcctcactctgcccggtcgaagttcgggtatagtgcgaaggacgttcgctccttgtccagcagggccattaaccagatccgctccgtctgggaggacttgctggaagacaccacaactccaattccaaccaccatcatggcgaagaacgaggtgttttgtgtggaccccgctaaagggggccgcaagcccgctcgcctcattgtgtaccctgacctgggggtgcgtgtctgtgagaaacgcgccctatatgacgtgatacagaagttgtcaattgagacgatgggttctgcttacggattccaatactcgcctcaacagcgggtcgaacgtctgctgaagatgtggacctcaaagaaaacccccttggggttctcgtatgacacccgctgctttgactcaactgtcactgaacaggacatcagggtggaagaggagatataccaatgctgtaaccttgaaccggaggccaggaaagtgatctcctccctcacggagcggctttactgcgggggccctatgttcaacagcaagggggcccagtgtggttatcgccgttgccgtgccagtggagttctgcctaccagcttcggcaacacaatcacttgttacatcaaggccacagcggctgcgaaggccgcaggcctccggaacccggactttcttgtctgcggagatgatctggtcgtggtggctgagagtgatggcgtcgatgaggatagagcagccctgagagccttcacggaggctatgaccaggtattctgctccacccggagatgctccacagcccacctacgaccttgagcttatcacatcttgctcctccaacgtctccgtggcacgggacgacaaggggaagaggtactattacctcacccgtgatgccactactcccctagcccgtgcggcttgggaaacagctcgtcacactccagttaactcctggttaggcaacatcatcatgtacgcgcctaccatctgggtgcgcatggtaatgatgacacactttttctccatactccaatcccaggagatacttgatcgaccccttgactttgaaatgtacggggccacttactctgtcactccgctggatttaccagcaatcattgaaagactccatggtctaagcgcgttcacgctccacagttactctccagtagagctcaatagggtcgcggggacactcaggaagcttgggtgcccccccctacgagcttggagacatcgggcacgagcagtgcgcgctaagcttatcgcccagggagggaaggccaaaatatgcggcctttatctctttaattgggcggtacgcaccaagaccaaactcactccactgccagccgctggccagttggatttgtccagctggtttacggttggcgtcggcgggaacgacatttatcacagcgtgtcgcgtgcccgaacccgctatttgctgctttgcctactcctactaacggtaggggtaggcatctttctcctgccagctcgg

SEQ ID NO: 106 - DNA, 1311 bp, Hepatitis C virus
gagtgtaccactccatgctccggttcctggctaagggacatctgggactggatatgcgaggtgctgagcgactttaagacctggctgaaagccaagctcatgccacaactgcctgggattccctttgtgtcctgccagcgcgggtataggggggtctggcgaggggacggcattatgcacactcgctgccactgtggagctgagatcactggacatgtcaaaaacgggacgatgaggatcgtcggtcctaggacctgcaggaacatgtggagtgggaccttccccattaacgcctacaccacgggcccctgtactccccttcctgcgccgaactataagttcgcgctgtggagggtgtctgcagaggaatacgtggagataaggcgggtgggggacttccactacgtgacgggtatgactactgacaatcttaaatgcccgtgccaggtcccatcgcccgaatttttcacagaattggacggggtgcgcctacataggtttgcgcccccctgcaagcccttgctgcgggaggaggtatcattcagagtaggactccacgagtacccggtggggtcgcaattaccttgcgagcccgaaccggacgtggccgtgttgacgtccatgctcactgatccctcccatataacagcagaggcggccgggagaaggttggcgaggggatcacccccttctgtggccagctcctcggctagccagctgtccgctccatctctcaaggcaacttgcaccgccaaccatgactcccctgacgccgagctcatagaggctaacctcctgtggaggcaggagatgggcggcaacatcaccagggttgagtcagagaacaaagtggtgattctggactccttcgatccgcttgtggcggaggaggatgagcgggaggtctccgtacccgcagaaatcctgcggaagtctcggagattcgcccaggccctgcccgtttgggcgcggccggactacaaccccccgctagtagagacgtggaaaaagcctgactacgaaccacctgtggtccatggctgcccgcttccacctccacagtcccctcctgtgcctccgcctcggaagaagcggacggtggtcctcaccgaatcaaccctatctactgccttggccgagcttgccaccaaaagttttggcagctcctcaacttccggcattacgggcgacaatacgacaacatcctctgagcccgccccttctggctgcccccccgactccgacgctgagtcctattcttccatgccccccctggagggggagcctggggatccggatctcagcgacggg

SEQ ID NO: 107 - DNA, 63 bp, Hepatitis C virus
cctgacgccgagctcataaaggctaacctcctatggagacaagaaatgggcggcaacatcacc

SEQ ID NO: 108 - DNA, 1341 bp, Hepatitis C virus
tgctccggctcgtggctaagggatgtttgggactggatatgcacggtgttgactgacttcaagacctggctccagtccaagctcctgccgcggttaccgggagtccctttcctctcatgccaacgtgggtacaagggagtctggcggggagacggcatcatgcaaaccacctgcccatgtggagcacagatcaccggacatgtcaaaaacggttccatgaggatcgttgggcctaaaacctgcagcaacacgtggcatggaacattccccatcaacgcatacaccacgggcccctgcacaccctccccggcgccaaactattccagggcgctgtggcgggtggctgctgaggagtacgtggaggttacgcgggtgggggatttccactacgtgacgggcatgaccactgacaacgtaaagtgcccatgccaggttccggcccccgaattcttcacggaggtggatggggtgcggctgcacaggtacgctccggcgtgcaaacctctcctacgggaggaggtcacattccaggtcgggctcaaccaatacctggttgggtcacagctcccatgcgagcccgaaccggatgtagcagtgctcacttccatgctcaccgacccctcccacattacagcagagacggctaagcgtaggctggccagggggtctcccccctccttggccagctcttcagctagccagttgtctgcgccttccttgaaggcgacatgcactacccatcatgactccccagacgctgacctcatcgaggccaacctcctgtggcggcaggagatgggcgggaacatcacccgcgtggagtcagagaataaggtagtaattctggactctttcgacccgcttcgagcggaggaggatgagagggaagtatccgttgcggcggagatcctgcggaaatccaggaagttccccccagcgatgcccatatgggcacgcccggattacaaccctccactgctagagtcctggaaggacccggactacgtccctccggtggtacacgggtgcccattgccacctaccaaggcccctccaataccacctccacggagaaagaggacggttgtcctgacagaatccaccgtgtcttctgccttggcggagctcgctacaaagaccttcggcagctccggatcgtcggccgtcgacagcggcacggcgaccgcccctcctgaccaggcctccgacgacggcgacacaggatccgacgttgagtcgtactcctccatgcccccccttgagggggagccgggggaccccgatctcagcgacgggtcttggtctaccgtgagcgaggaggctagtgaggacgtcgtctgc

SEQ ID NO: 109 - DNA, 830 bp, Hepatitis C virus
cttgtgaccctgagcccgacacagacgtattgatgtccatgctaacagatccatcccatatcacggcggaggctgcagcgcggcgcttagcgcgggggtcacccccatctgaggcaagctcctcagcgagccagctatcggcaccatcgctgcgagccacctgcaccacccacggcaagacctatgatgtggacatggtggatgccaacctgttcatggggggcgatgtgactcggatagagtctgagtccaaagtggtcgttctggactctctcgacccaatggccgaagaaaagagcgacctcgagccttcgataccatcggagtatatgctccccaggaacaggttcccaccagccttaccggcctgggcacggcctgattacaacccaccgcttgtggaatcgtggaagaggccagattaccaaccgcccactgttgcgggctgtgctctccccccccccaagaagaccccgacgccccccccaaggagacgccggacagtgggtctgagcgagagcaccataggagatgccctccaacagctggccatcaagaccttcggccagccccccccaagcggcgattcaggcctttccacgggggcggacgccgccgactccggcggtcggacgccccctgatgagttggctctttcggagacaggttccatctcctccatgccccccctcgagggggagcctggggatccagacctggagcctgagcaggtagagcttcaacctcccccccaggggggggaggtagctcccggctcggactcggggtcctggtctacttgctccgaggaggatgactccgtcgtgtgc

SEQ ID NO: 110 - DNA, 830 bp, Hepatitis C virus
cttgcgaccctgagccggacaccgaggtattggcctccatgttgacagacccgtcccacattaccgcggaggcggcagccaggcggttggccaggggatctcccccttcacaggccagctcttcagcgagccagctctccgccccgtccttgaaggctacctgtaccacccataagatggcatatgattgtgacatggtggatgctaaccttttcatgggaggcgatgtgacccggattgagtccgactctaaggtgatcgttctcgactccctcgattccatgactgaggtagaggatgatcgtgagccttctgtaccatcagagtacttgatcaggaggagaaagttcccaccggcactacctccctgggcccgtccagactacaaccctcctgtgatcgagacatggaagaggccgggctatgaaccacccactgtcctaggctgtgcccttccccccacacctcaagcgccagtgcccccacctcggaggcgccgcgccaaagtcctgactcaggacaatgtggagggggtcctcagggagatggcggacaaagtgctcagccctctccaagaccacaatgactccggtcactccactggagcggataccggaggagacagcgtccagcagccctctgacgagactgccgcttcagaagcgggatcactgtcctccatgcctccccttgagggagagccgggggaccctgacctggagtttgaaccagcgggatccgctcccccttctgagggggagtgtgaggtcattgattcggactctaagtcgtggtccacagtctctgatcaagaggattctgttatctgc

SEQ ID NO: 111 - DNA, 788 bp, Hepatitis C virus
cctgtgagccagaaccagatgtttctgtgctgacctcgatgttgagagacccttcccatatcaccgccgagacggcagcgcgccgccttgcgcgcgggtcccctccatcagaggcaagctcatccgccagccaactatcggctccgtcgttgaaggccacttgccagacgcataggcctcatccagacgctgagctagtagacgccaacttgttatggcggcaagagatgggcagcaacattacacgggtggagtctgaaacaaaggttgtgattcttgattcattcgaacctctgagagccgaaactgatgacgccgagctctcggtggctgcagagtgtttcaagaaacctcccaagtatcctccagcccttcctatctgggctaggccggactacaaccctccactgttggaccgctggaaagcaccggattatgtaccaccaactgtccatggatgtgccttaccaccacggggcgctccaccggtgcctcctcctcggaggaaaagaacaattcagctggacggttccaatgtgtccgcggcgttagctgcgctagcggaaaaatcattcccgtccttgaaaccgcaggaagagaatagctcatcctctggggtcgacacacagtccagcactacttccaaggtgcccccttctccgggaggggagtccgactcagagtcatgctcgtccatgcctcctctcgagggagagccgggcgatccggacttgagttgcgactcttggtccaccgttagtgacagcgaggagcagagcgtggtctgc

SEQ ID NO: 112 - DNA, 3416 bp, Hepatitis C virus
gccagccccctgatgggggcgacactccaccatgaatcactcccctgtgaggaactactgtcttcacgcagaaagcgtctagccatggcgttagtatgagtgtcgtgcagcctccaggaccccccctcccgggagagccatagtggtctgcggaaccggtgagtacaccggaattgccaggacgaccgggtcctttcttggataaacccgctcaatgcctggagatttgggcgtgcccccgcaagactgctagccgagtagtgttgggtcgcgaaaggccttgtggtactgcctgatagggtgcttgcgagtgccccgggaggtctcgtagaccgtgcaccatgagcacgaatcctaaacctcaaagaaaaaccaaacgtaacaccaaccgtcgcccacaggacgtcaagttcccgggtggcggtcagatcgttggtggagtttacttgttgccgcgcaggggccctagattgggtgtgcgcgcgacgaggaagacttccgagcggtcgcaacctcgaggtagacgtcagcctatccccaaggcacgtcggcccgagggcaggacctgggctcagcccgggtacccttggcccctctatggcaatgagggttgcgggtgggcgggatggctcctgtctccccgtggctctcggcctagctggggccccacagacccccggcgtaggtcgcgcaatttgggtaaggtcatcgatacccttacgtgcggcttcgccgacctcatggggtacataccgctcgtcggcgcccctcttggaggcgctgccagggccctggcgcatggcgtccgggttctggaagacggcgtgaactatgcaacagggaaccttcctggttgctctttctctatcttccttctggccctgctctcttgcctgactgtgcccgcttcagcctaccaagtgcgcaattcctcggggctttaccatgtcaccaatgattgccctaactcgagtattgtgtacgaggcggccgatgccatcctgcacactccggggtgtgtcccttgcgttcgcgagggtaacgcctcgaggtgttgggtggcggtgacccccacggtggccaccagggacggcaaactccccacaacgcagcttcgacgtcatatcgatctgcttgtcgggagcgccaccctctgctcggccctctacgtgggggacctgtgcgggtctgtctttcttgttggtcaactgtttaccttctctcccaggcgccactggacgacgcaagactgcaattgttctatctatcccggccatataacgggtcatcgcatggcatgggatatgatgatgaactggtcccctacggcagcgttggtggtagctcagctgctccggatcccacaagccatcatggacatgatcgctggtgctcactggggagtcctggcgggcatagcgtatttctccatggtggggaactgggcgaaggtcctggtagtgctgctgctatttgccggcgtcgacgcggaaacccacgtcaccgggggaagtgccggccgcaccacggctgggcttgttggtctccttacaccaggcgccaagcagaacatccaactgatcaacaccaacggcagttggcacatcaatagcacggccttgaactgcaatgaaagccttaacaccggctggttagcagggctcttctatcaccacaaattcaactcttcaggctgtcctgagaggttggccagctgccgacgccttaccgattttgcccagggctggggtcctatcagttatgccaacggaagcggcctcgaccaacgcccctactgctggcactaccctccaaaaccttgtggtattgtgcccgcaaagagcgtgtgtggcccggtatattgcttcactcccagccccgtggtggtgggaacgaccgacaggtcgggcgcgcctacctacagctggggtgcaaatgatacggacgtcttcgtccttaacaacaccaggccaccgctgggcaattggttcggttgtacctggatgaactcaactggattcaccaaagtgtgcggagcgcccccttgtgtcatcggaggggtgggcaacaacaccttgctctgccccactgattgcttccgcaagcatccggaagccacatactctcggtgcggctccggtccctggattacacccaggtgcatggtcgactacccgtataggctttggcactatccttgtaccatcaattacaccatattcaaagtcaggatgtacgtgggaggggtcgagcacaggctggaagcggcctgcaactggacgcggggcgaacgctgtgatctggaagacagggacaggtccgagctcagcccgttgctgctgtccaccacacagtggcaggtccttccgtgttctttcacgaccctgccagccttgtccaccggcctcatccacctccaccagaacattgtggacgtgcagtacttgtacggggtggggtcaagcatcgcgtcctgggccattaagtgggagtacgtcgttctcctgttccttctgcttgcagacgcgcgcgtctgctcctgcttgtggatgatgttactcatatcccaagcggaggcggctttggagaacctcgtaatactcaatgcagcatccctggccgggacgcacggtcttgtgtccttcctcgtgttcttctgctttgcgtggtatctgaagggtaggtgggtgcccggagcggtctacgccctctacgggatgtggcctctcctcctgctcctgctggcgttgcctcagcgggcatacgcactggacacggaggtggccgcgtcgtgtggcggcgttgttcttgtcgggttaatggcgctgactctgtcaccatattacaagcgctatatcagctggtgcatgtggtggcttcagtattttctgaccagagtagaagcgcaactgcacgtgtgggttccccccctcaacgtccggggggggcgcgatgccgtcatcttactcatgtgtgttgtacacccgactctggtatttgacatcaccaaactactcctggccatcttcggacccctttggattcttcaagccagtttgcttaaagtcccctacttcgtgcgcgttcaaggccttctccggatctgcgcgctagcgcggaagatagccggaggccattacgtgcaaatggccatcatcaagttaggggcgcttactggcacctatgtgtataaccatctcacccctcttcgagactgggcgcacaacggcctgcgagatctggccgtggctgtggaaccagtcgtcttctcccgaatggagaccaagctcatcacgtggggggcagataccgccgcgtgcggtgacatcatcaacggcttgcccgtctctgcccgtaggggccaggagatactgcttgggccagccgacggaatggtctccaaggggtggaggttg

SEQ ID NO: 113 - DNA, 789 bp, Hepatitis C virus
tgctctcagcacttaccgtacatcgagcaagggatgatgctcgctgagcagttcaagcagaaggccctcggcctcctgcagaccgcgtcccgccaggcagaggttatcacccctgctgtccagaccaactggcagaaactcgaggccttctgggcgaagcacatgtggaatttcatcagtgggatacaatacttggcgggcctgtcaacgctgcctggtaaccccgccattgcttcattgatggcttttacagctgccgtcaccagcccactaaccactagccaaaccctcctcttcaacatattgggggggtgggtggctgcccagctcgccgcccccggtgccgctaccgcctttgtgggcgctggcttagctggcgccgccatcggcagcgttggactggggaaggtcctcgtggacattcttgcagggtatggcgcgggcgtggcgggagctcttgtggcattcaagatcatgagcggtgaggtcccctccacggaggacctggtcaatctgctgcccgccatcctctcgcctggagcccttgtagtcggtgtggtctgtgcagcaatactgcgccggcacgttggcccgggcgagggggcagtgcaatggatgaaccggctaatagccttcgcctcccgggggaaccatgtttcccccacgcactacgtgccggagagcgatgcagccgcccgcgtcactgccatactcagcagcctcactgtaacccagctcctgaggcgactgcatcagtggataagctcggagtgtaccactccatgctcc

SEQ ID NO: 114 - DNA, 20 bp, Human immunodeficiency virus
cagagcagaccagagccaac

SEQ ID NO: 115 - DNA, 30 bp, Human immunodeficiency virus
aatgcttttattttttcttctgtcaatggc

SEQ ID NO: 116 - DNA, 18 bp, Human immunodeficiency virus
ttggaaatgtggaaagga

SEQ ID NO: 117 - DNA, 18 bp, Human immunodeficiency virus
cctagtgggatgtgtact

SEQ ID NO: 118 - DNA, 35 bp, Human immunodeficiency virus
ttggttgcactttaaattttcccattagtcctatt

SEQ ID NO: 119 - DNA, 29 bp, Human immunodeficiency virus
cctactaacttctgtattcattgacagtc

SEQ ID NO: 120 - DNA, 23 bp, Human immunodeficiency virus
ggaatcattcaagcacaaccaga

SEQ ID NO: 121 - DNA, 24 bp, Human immunodeficiency virus
tctcctgtatgcagaccccaatat

SEQ ID NO: 122 - DNA, 20 bp, Human immunodeficiency virus
tctacctggcatgggtacca

SEQ ID NO: 123 - DNA, 23 bp, Human immunodeficiency virus
cctagtgggatgtgtacttctga

SEQ ID NO: 124 - DNA, 20 bp, Hepatitis C virus
gggtgaggtccagatygtgt

SEQ ID NO: 125 - DNA, 20 bp, Hepatitis C virus
tggtraargtaggrtcragg

SEQ ID NO: 126 - DNA, 20 bp, Hepatitis C virus
atcaayggggtrtgctggac

SEQ ID NO: 127 - DNA, 20 bp, Hepatitis C virus
gggctgcchgtrgtaattgt

SEQ ID NO: 128 - DNA, 30 bp, Hepatitis C virus
tggggatcccgtatgatacccgctgctttg

SEQ ID NO: 129 - DNA, 30 bp, Hepatitis C virus
ggcggaattcctggtcatagcctccgtgaa

SEQ ID NO: 130 - DNA, 24 bp, Hepatitis C virus
ctcaaccgtcactgagagagacat

SEQ ID NO: 131 - DNA, 23 bp, Hepatitis C virus
gctctcaggctcgccgcgtcctc